(19) United States
(12) Patent Application Publication
(10) Pub. No.: US 2026/0320302 A1
(43) Pub. Date: Oct. 15, 2026

(54) AGENT-BASED CONVERSATIONAL DIALOGUE SYSTEM

(71) Applicant: UNIVERSITY OF SOUTH FLORIDA, Tampa, FL (US)

(72) Inventors: Gerald IMAEZUE, Tampa, FL (US); Harikrishna MARAMPELLY, Tampa, FL (US); Krishna VENI MARAM, Tampa, FL (US)

(21) Appl. No.: 19/646,520

(22) Filed: Apr. 13, 2026

Related U.S. Application Data
(60) Provisional application No. 63/787,438, filed on Apr. 11, 2025.

(51) Int. Cl. G06F 40/35; G10L 13/027; G10L 15/26

(52) U.S. Cl. CPC G06F 40/35; G10L 13/027; G10L 15/26

(57) ABSTRACT

A system comprises a processor and a non-transitory computer-readable storage medium storing instructions that, when executed by the processor, cause the system to provide a shared context stimulus comprising a session goal for a dialogue session to an AI speaker agent comprising a first large language model and an AI interlocutor agent comprising a second large language model; generate a speaker prompt specifying a target error type from a predefined error taxonomy and constraining the AI speaker agent to conform utterances to the target error type; generate an interlocutor prompt constraining the AI interlocutor agent to identify the target error type in received utterances and generate response utterances determined by the session goal; iteratively execute the dialogue session, each iteration comprising text-to-speech and speech-to-text conversions and application of an acoustic signal transformation to synthesized speech based on acoustic characteristics associated with the target error type; and store a dialogue session transcript.

### CROSS-REFERENCE TO RELATED APPLICATIONS

This application claims priority to U.S. Provisional Application No. 63/787,438, filed on Apr. 11, 2025, the entire contents of which are hereby incorporated by reference in their entirety.

### STATEMENT REGARDING FEDERALLY SPONSORED RESEARCH

This invention was made with government support under P2CHD101899 awarded by the National Institutes of Health. The government has certain rights in the invention.

### BACKGROUND

Speech and language, while closely related, are distinct domains. Speech refers to the acoustic, phonetic, and articulatory properties of spoken output, including the physical signal produced by the vocal tract. Language refers to the linguistic, syntactic, semantic, and pragmatic properties of the message being communicated, including the cognitive and structural organization of meaning. For individuals with acquired or developmental communication disorders, both speech and language may be impaired. Aphasia, for example, is a condition arising from neurological events (such as stroke, traumatic brain injuries, or degenerative diseases) and is characterized by fragmented and constrained speech outputs that significantly impact quality of life. Individuals with aphasia often experience difficulty forming words, constructing sentences, and maintaining fluency in spontaneous speech, leading to substantial challenges in personal, social, and professional interactions.

Response Elaboration Training (RET) is an evidence-based therapeutic approach designed to expand and shape connected speech production in individuals with aphasia through a structured chaining technique. In RET, a clinician responds to patient utterances by modeling and reinforcing elaborated responses without directly correcting errors, thereby prompting elaboration of responses over successive turns. Traditional speech therapy for aphasia and related speech impairments typically involves structured exercises conducted under the guidance of a speech-language pathologist (SLP). Such interventions often rely on modeling and external feedback to reinforce correct speech patterns. For example, conventional approaches involve a speech-language pathologist providing an example of correct speech production, which the patient is then expected to imitate or repeat. The pathologist listens to the response, manually assesses accuracy of the repeated speech in real time, and provides feedback to the patient accordingly during the appointment.

### SUMMARY

The following presents a simplified summary of one or more aspects of the present disclosure in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its purpose is to present certain concepts of one or more aspects of the disclosure in a simplified form as a prelude to the more detailed description that is presented later.

The present disclosure provides systems and methods that enable AI-powered conversational agents to interact effectively with individuals who produce disordered speech. In certain embodiments, the disclosed systems constrain LLM-based conversational agents to generate contextually appropriate responses even when receiving aphasic and other disordered speech utterances that might otherwise function as adversarial prompts. For example, an AI clinician agent administering RET using a picture depicting “a boy kicking a ball” may be configured to correctly interpret a phonemically distorted utterance such as “boy uhm kick /f/all” without erroneously elaborating as though the patient said the boy fell. Furthermore, the disclosed systems provide scalable approaches for generating synthetic disordered speech data for fine-tuning AI models, reducing dependency on recruiting individuals with specific speech-language disorders for data collection.

In one aspect, the present disclosure provides systems and methods that simulate disordered speech in a controlled, structured manner to enable evaluation and improvement of AI conversational agents prior to clinical deployment. In certain embodiments, the present disclosure further provides systems that generate labeled corpora of disordered speech (encompassing both linguistic error patterns and acoustic characteristics) to train and fine-tune conversational AI systems to be robust when interacting with speakers who produce disordered speech. Such systems serve as preclinical testbeds for evaluating and selecting AI agents and prompts, reducing dependency on scarce human disordered speech data. In further embodiments, the disclosed systems may be used to actively train or fine-tune AI or machine learning models in real time using the simulated dialogue environment itself as the training substrate, or to generate labeled training data suitable for training downstream AI systems across a wide range of applications beyond speech therapy, including customer service, hospitality, healthcare communication, and automated ordering systems.

In one aspect, the present disclosure provides a system for AI dialogue simulation and evaluation. The system may include a processor and a non-transitory computer-readable storage medium storing instructions that, when executed by the processor, cause the system to provide a shared context stimulus comprising a session goal for a dialogue session to an AI speaker agent comprising a first large language model and an AI interlocutor agent comprising a second large language model; generate a speaker prompt specifying a target error type and constraining the AI speaker agent to conform utterances to the target error type; generate an interlocutor prompt constraining the AI interlocutor agent to identify the target error type and generate response utterances with a response structure determined by the session goal; iteratively execute the dialogue session with text-to-speech and speech-to-text conversions and acoustic signal transformations; and store a transcript of the dialogue session. In a further aspect, the present disclosure provides a system for speech corpus generation that generates candidate utterances exhibiting specified error types, converts them to acoustically-transformed synthesized speech, scores them for quality, and stores them in a labeled corpus. Further aspects include methods and non-transitory computer-readable media for performing the foregoing operations.

These and other aspects of the disclosure will become more fully understood upon a review of the drawings and the detailed description that follows. Other aspects, features, and embodiments of the present disclosure will become apparent to those skilled in the art upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various other embodiments of the disclosure discussed herein. Similarly, while example embodiments may be discussed below as device, system, or method embodiments, it should be understood that such example embodiments can be implemented in various devices, systems, and methods.

### BRIEF DESCRIPTION OF THE DRAWINGS

FIG. 1 is a block diagram illustrating a system for AI dialogue simulation and evaluation according to an embodiment of the present disclosure.

FIG. 2 is a block diagram illustrating a system for speech corpus generation according to an embodiment of the present disclosure.

FIG. 3 is an illustration of an example user interface for configuring a dialogue simulation session according to an embodiment of the present disclosure.

FIG. 4 is a flowchart illustrating a method for generating a speech corpus according to an embodiment of the present disclosure.

FIG. 5 is a flowchart illustrating a method for executing an AI dialogue simulation session according to an embodiment of the present disclosure.

FIG. 6 is a block diagram illustrating a computing environment suitable for implementing the systems and methods disclosed herein.

FIGS. 7A, 7B, and 7C are tabular illustrations of example dialogue transcripts produced by the dialogue simulation system under different target error types and session topics.

### DETAILED DESCRIPTION

The following detailed description is provided to enable any person skilled in the relevant art, including speech pathologists, clinical linguists, and AI/ML engineers, to make and use the disclosed subject matter. The described embodiments are non-limiting examples, and the scope of the disclosure may be defined by the appended claims. Unless otherwise stated, the term “comprising” and its variants may be used in an open-ended sense. All reference numerals appearing herein may correspond to the elements labeled in the accompanying drawings.

The present disclosure describes two closely related systems, methods, and computer-readable media. The first may be an AI dialogue simulation system (hereinafter referred to as the “conversation simulator”) that may enable a pair of AI agents (namely, an AI speaker agent and an AI interlocutor agent) to conduct a structured, turn-based simulated dialogue in which the speaker agent may produce utterances conforming to a specified speech-language error type, and the interlocutor agent may identify those errors and generate responses consistent with a defined session goal. The second may be a speech corpus generation system that may use an AI speaker agent operating under a constrained generation prompt to generate a plurality of candidate utterances exhibiting specified speech-language error types, may convert those utterances to acoustically-transformed synthesized speech, may score them for quality, and may store them in a labeled corpus. The two systems may be related and complementary. The corpus generation system may operate independently of any dialogue framework, or it may leverage the dialogue simulation system as a source of candidate utterances.

In certain embodiments, the disclosed systems and methods may define a computer-implemented architecture that constrains LLM generation through a structured error taxonomy, integrates the constrained LLM with a closed-loop text-to-speech, acoustic-perturbation, and speech-to-text pipeline to produce acoustically realistic disordered speech, and automates quality-controlled corpus construction. In some embodiments, the disclosed systems may define a pipeline architecture comprising specific, interoperating computational components (including error-type-conditioned prompt generation, turn-level instruction chaining between two independently constrained LLM agents, deterministic acoustic signal transformation, and automated quality-gated corpus assembly) that together may be configured to generate, evaluate, and curate synthetic disordered speech data.

In certain embodiments, the disclosed systems and methods may address technical considerations in AI engineering and computational linguistics. In some embodiments, the systems may provide a scalable, automated mechanism for generating synthetic disordered speech data that may be both linguistically accurate (exhibiting well-defined error types conforming to a formal clinical taxonomy) and acoustically realistic (exhibiting the prosodic, temporal, and spectral characteristics of disordered speech production). Generating such data through conventional means may involve recruiting individuals with specific speech-language disorders, recording their speech in controlled environments, and manually annotating the resulting recordings—a process that may be expensive, logistically difficult, limited in scale, and constrained by the availability of willing participants with the precise disorder profile needed. In certain embodiments, the disclosed systems may provide an automated pipeline capable of producing linguistically-typed and acoustically-transformed synthetic disordered speech at scale with integrated quality control. In further embodiments, the systems may provide a method for evaluating conversational AI agents' robustness to disordered or atypical speech inputs prior to deployment. Conventional evaluation of conversational AI agents may rely on scripted test cases, pre-recorded utterance sets, or live human testing. In certain embodiments, the present disclosure may provide a dynamic, stochastic simulation environment in which a conversational AI agent may be exposed to a distribution of linguistically-typed disordered utterances generated at runtime, which may enable systematic evaluation across a full error taxonomy without requiring human participants. In some embodiments, the systems may address the susceptibility of large language models to generating contextually inappropriate responses when receiving inputs that deviate from normative language patterns. Disordered speech utterances—characterized by phonemic substitutions, semantic paraphasias, syntactic disruptions, perseverative repetitions, tangential topic shifts, and involuntary language mixing—may function as adversarial inputs to LLMs, potentially causing the model to misinterpret the speaker's communicative intent and generate responses that are contextually inappropriate, clinically harmful, or nonsensical. In certain embodiments, the present disclosure may address this by providing a specific external computational architecture—comprising error-type-conditioned prompt generation from a formal error taxonomy, dual-agent turn-level instruction chaining through a TTS/STT acoustic communication channel, deterministic DSP-based acoustic signal transformation, and automated quality-gated corpus assembly—that may constrain, evaluate, and adjust the LLM's behavior when confronted with such inputs.

In certain embodiments, the disclosure may define a specific multi-component technical architecture comprising: (a) a formal error taxonomy encoding clinically-defined categories of speech-language errors with associated linguistic transformation rules and acoustic perturbation parameters; (b) an error-type-conditioned prompt generation mechanism that may programmatically construct role-specific prompts encoding the selected error type's transformation rules and behavioral constraints; (c) a dual-agent dialogue execution engine that may chain two independently-constrained LLM agents through a TTS/STT acoustic communication channel, with each agent operating under its own role-specific prompt and with the dialogue history buffer updated at each turn; (d) a deterministic acoustic signal transformation pipeline that may apply parameterized DSP operations (time-stretching, silence insertion, onset delay, spectral modification) to synthesized speech based on the acoustic characteristics associated with the target error type; and (e) an automated quality-gated corpus assembly pipeline that may score candidate utterances for conformity to the target error type and may store only those satisfying a minimum quality threshold, together with their acoustically-transformed audio, error type labels, and quality scores. Each of these components may perform a specific technical function, and their integration into a closed-loop pipeline may produce a composite technical output (acoustically-realistic, linguistically-typed, quality-scored synthetic disordered speech).

The two disclosed systems may implement a framework referred to herein as Agent-Based Conversational Dialogue (hereinafter “ABCD”). ABCD may be a method for simulating goal-driven natural spoken dialogues between conversational AI agents in a particular context. ABCD may be useful for modeling and developing conversational AI agents navigating communication challenges (such as disordered speech) and for evaluating their behaviors in simulated natural spoken dialogue settings. The ABCD framework may model speech interactions between two AI agents in context-rich environments (such as topics or pictures) and may provide a scalable alternative to collection and fine-tuning on human speech data, by integrating agent-based modeling with speech-based conversational AI to simulate realistic speech exchanges tailored to specific scenarios. ABCD may provide a method for developing, prototyping, and piloting scalable conversational AI partners (such as those for speech-language therapy) in simulated natural spoken dialogue settings prior to human testing. This method may expedite the development of conversational AI agents that potentially supplement human-driven treatments and extend essential care to underserved populations. ABCD may enable controlled, multi-turn natural spoken dialogue simulations between an LLM-driven interlocutor (e.g., an artificial intelligence speech-language pathologist (AI-SLP)) and another AI agent that may produce characteristic features of impaired language (AI-Patient). The modular design of ABCD may support manipulation of reasoning strategies, communicative intent, and perturbations to input (such as error types or multimodal distortions). This approach may enable preclinical assessment of conversational behavior without requiring human participants and may provide a scalable testbed for investigating how LLMs adapt to noisy, atypical, or clinically relevant language. In certain embodiments, the disclosure may expedite the development, simulation, and testing of speech-based conversational AI agents. The simulator may enable developers to model and test speech interactions between a target conversational agent and a simulated counterpart that replicates the behaviors of a target audience, and to fine-tune or select among LLMs to find responses best aligned with desired outcomes.

In certain embodiments, the ABCD framework may be configured to operate across a plurality of natural languages, including but not limited to English, Spanish, French, Mandarin Chinese, Arabic, Portuguese, German, Japanese, Korean, Hindi, and other languages for which suitable large language models, text-to-speech engines, and speech-to-text engines are available. The predefined error taxonomy, the error-type-conditioned prompt generation mechanism, and the acoustic signal transformation pipeline may each be parameterized for language-specific phonological, morphosyntactic, and prosodic characteristics, such that the AI speaker agent may produce linguistically accurate disordered speech in the target language and the AI interlocutor agent may generate contextually appropriate responses in that same language. For example, in a Spanish-language implementation, the AI speaker agent may be constrained to produce phonemic errors reflecting Spanish phonological inventory (e.g., substituting /r/ for /l/ or producing seseo-related substitutions), syntactic errors reflecting Spanish word-order flexibility and clitic placement disruptions, and semantic errors involving semantically related Spanish lexical items. In a Mandarin Chinese implementation, the AI speaker agent may be constrained to produce tone-related errors (e.g., producing a word with an incorrect lexical tone, thereby changing its meaning), phonemic errors involving Mandarin-specific onset and final substitutions, and syntactic errors reflecting disruptions to Mandarin topic-comment structure or classifier usage. The multilingual capability of the system may be enabled by the LLM-agnostic and language-parameterized architecture of the prompt generation and acoustic transformation components, which may allow the system to be reconfigured for a new target language by specifying language-appropriate error taxonomy entries, prompt templates, TTS voice identifiers, and STT language models without requiring modification of the underlying pipeline architecture.

In some examples, the simulated dialogue may be dynamic and stochastic rather than static or scripted. Unlike evaluation approaches that may rely on pre-recorded or fixed-sequence utterance sets, the ABCD system may generate each utterance at runtime through independent LLM inference conditioned on the evolving dialogue history and the speaker prompt or interlocutor prompt active for that session. Because LLM generation may be non-deterministic (token sampling may introduce variation across sessions even when the same prompt template and error type are used), each simulated dialogue session may produce a distinct sequence of utterances. This property may reflect the reality that human conversation is itself stochastic and dynamic: no two conversations between a clinician and a patient may be identical, even when the same topic, task, and error pattern are involved. By generating utterance sequences at runtime rather than replaying a fixed corpus, the system may expose the interlocutor agent to a distribution of conversational realizations rather than to any single fixed scenario, which may support more comprehensive evaluation of the interlocutor agent's ability to handle the variability inherent in real-world speech interactions. Operationally, the dynamic nature of the simulation may be achieved through the combination of: (a) per-turn LLM inference for both agents, conditioned on a growing dialogue history buffer that may be updated at each turn; (b) error-type-conditioned speaker prompts that may constrain the error category but may not prescribe specific utterance content, leaving the content of each errorful utterance to be determined by the LLM's sampling process; and (c) TTS/STT conversion that may introduce additional acoustic variation. This architecture may ensure that the interlocutor agent encounters novel surface forms of the target error type at each turn, rather than a fixed set of exemplars, and may therefore be evaluated under conditions that more closely approximate the variability of real-world interactions.

The ABCD framework may operate through specific architectural and operational mechanisms. First, the system may employ structured prompt engineering in which each AI agent operates under a distinct, role-specific prompt template that may encode a formal error taxonomy (comprising defined categories of word-level errors (phonemic, semantic, perseveration, and structural/syntactic) and discourse-level errors (tangential speech and pathological language mixing)) and may constrain the LLM's token generation to conform solely to a specified error type within that taxonomy during any given session. This error-type-conditioned prompt generation may not be a generic instruction to “produce errors” but rather a technically specific mechanism that may map each error category to defined linguistic transformation rules (e.g., phonological substitution patterns, syntactic reordering rules, perseverative repetition constraints) embedded within the prompt structure. Second, the system may implement turn-level instruction chaining, in which the AI interlocutor agent's prompt may be structured to require, at each dialogue turn, identification of the specific error type present in the received utterance before generating a response, thereby creating a closed-loop feedback mechanism within the dialogue that may be architecturally distinct from single-turn LLM inference. Third, the integration of the LLM-generated text with a deterministic acoustic signal transformation pipeline (operating independently of any machine learning model) may produce a composite output of acoustically-transformed synthesized speech that no single LLM or machine learning model could produce alone.

In certain embodiments, the specific technical configuration of the disclosed systems may be described as follows. First, the error-type-conditioned prompt generation mechanism may operate as a programmatic mapping from a structured data object (an entry in the predefined error taxonomy, comprising an error type identifier, a set of defining linguistic characteristics, a set of linguistic transformation rules, and a set of acoustic perturbation parameters) to a natural-language prompt string that may encode those characteristics and rules in a form consumable by an LLM's token generation process. This mapping may be a deterministic, parameterized transformation that may produce a distinct prompt for each error type in the taxonomy, with each prompt encoding error-type-specific transformation rules (e.g., for phonemic errors: specific phonological substitution patterns such as voicing changes, place-of-articulation shifts, and manner-of-articulation substitutions; for syntactic errors: specific word-order permutation rules such as subject-verb inversion, object fronting, and function-word deletion; for perseveration errors: specific repetition constraints specifying that a previously-produced lexical item must be substituted for contextually appropriate items in subsequent turns; for tangential speech: specific topic-drift instructions specifying that the agent must shift to an unrelated topic without explicit transition markers; for language mixing: specific code-switching instructions specifying that the agent must substitute lexical items from a specified second language at defined positions within the utterance). This level of specificity in prompt construction may serve as a technical mechanism that constrains the LLM's stochastic token generation process to produce outputs conforming to a defined linguistic specification, rather than relying on the LLM's general-purpose language generation capabilities.

Second, the dual-agent turn-level instruction chaining mechanism may be described as follows. In the disclosed architecture, two LLM agents may operate under independently-constructed, role-specific prompts and may exchange utterances not through direct text passing but through an intermediate TTS/STT acoustic communication channel that may introduce realistic acoustic variation and may simulate the physical speech channel through which human interlocutors communicate. At each dialogue turn, the following sequence of technical operations may occur: (1) the sending agent's LLM may generate a text utterance conditioned on its role-specific prompt and the current dialogue history buffer; (2) a TTS engine may convert the text utterance to a speech audio waveform; (3) for the speaker agent's utterances, a deterministic DSP pipeline may apply acoustic signal transformations (time-stretching, silence insertion, onset delay, spectral modification) parameterized by the target error type's acoustic characteristics; (4) an STT engine may transcribe the (optionally transformed) audio waveform back to text; and (5) the resulting text transcript may be appended to the receiving agent's dialogue history buffer and supplied as input for the receiving agent's next turn. This TTS-DSP-STT intermediation may not be merely a format conversion; it may introduce acoustic variation that affects the STT transcription output, causing the receiving agent to encounter surface-form variations of the sending agent's utterances that may not be present in a text-only pipeline. This acoustic channel simulation may serve as a specific technical mechanism that exposes the interlocutor agent to the same kinds of transcription-mediated input distortions that may occur in a real-world speech interaction with a human speaker.

Third, the deterministic acoustic signal transformation pipeline may operate on the audio waveform independently of any machine learning model and may apply a defined set of parameterized signal-processing operations that may be selected and configured based on the target error type's acoustic characteristics. The specific DSP operations may include: (a) phase vocoder-based time stretching, which may modify the duration of individual syllables or vowel segments by a configurable stretch factor (e.g., 1.3× to 2.0× for simulating the prolonged syllable durations characteristic of non-fluent aphasia) without altering pitch, by decomposing the audio signal into overlapping windowed frames, computing the short-time Fourier transform (STFT) of each frame, interpolating the magnitude and phase spectra to achieve the target duration, and reconstructing the time-domain signal via inverse STFT and overlap-add synthesis; (b) sample-level silence insertion, which may insert silence segments of configurable duration (e.g., 200 ms to 1500 ms) at defined positions within the utterance (e.g., between words, between syllables, or at clause boundaries) to simulate the abnormal pausing patterns characteristic of disordered speech, by identifying word or syllable boundaries in the audio signal (using forced alignment or energy-based segmentation) and splicing zero-amplitude samples at the identified positions; (c) waveform onset delay, which may prepend a silence segment of configurable duration (e.g., 500 ms to 3000 ms) to the beginning of the utterance to simulate the initiation latency characteristic of certain motor speech disorders; (d) parametric spectral modification, which may apply frequency-domain filtering (e.g., formant shifting, spectral tilt adjustment, or band-pass filtering) to simulate voice quality differences associated with neurological speech disorders; and (e) fundamental frequency (F0) contour perturbation, which may apply pitch-domain transformations to the synthesized speech signal to simulate tone production errors characteristic of disordered speech in tonal languages such as Mandarin Chinese, Cantonese, Vietnamese, Thai, and Yoruba. In tonal languages, lexical meaning may be determined in part by the pitch contour (tone) applied to a syllable, and individuals with aphasia affecting tonal language production may exhibit flattened, reversed, or otherwise distorted tone contours that alter the intended lexical identity of the spoken word. The F0 contour perturbation operation may modify the pitch trajectory of individual syllables by applying parameterized transformations including tone flattening (replacing a dynamic tone contour with a level pitch), tone reversal (inverting the direction of a rising or falling tone), tone range compression (reducing the pitch excursion of a tone contour by a configurable factor), and inter-tone boundary smoothing (reducing the distinctiveness of tonal transitions between adjacent syllables), each of which may be implemented through pitch-synchronous overlap-add (PSOLA) synthesis or equivalent time-domain pitch modification techniques operating on the fundamental frequency trajectory extracted from the synthesized waveform. For non-tonal languages such as English, Spanish, and French, the F0 contour perturbation operation may be configured to simulate prosodic disruptions characteristic of motor speech disorders, including monotone pitch (reduced pitch variability across an utterance), inappropriate pitch accents, and disrupted intonation contours at phrase boundaries. These DSP operations may be deterministic (producing identical output for identical input and parameters), computationally efficient (operating in linear time with respect to signal length), and independently configurable for each error type in the taxonomy and for each target language. The combination of LLM-generated linguistically-typed text with deterministic DSP-generated acoustically-transformed audio may produce a composite output that spans both the linguistic and acoustic domains of disordered speech.

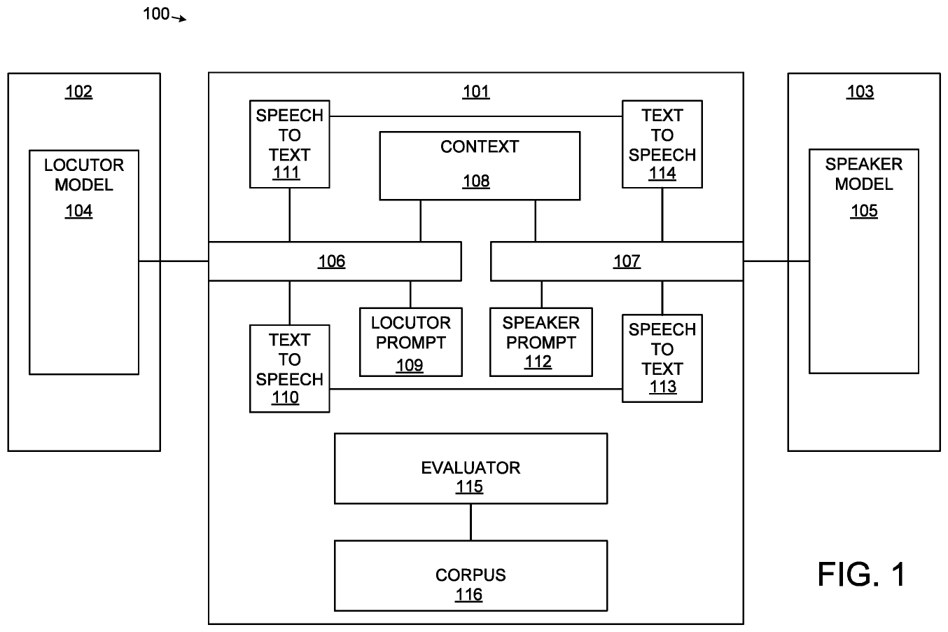

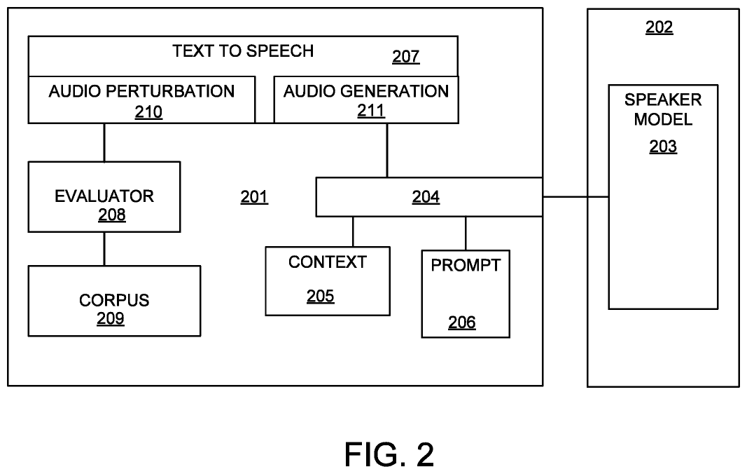

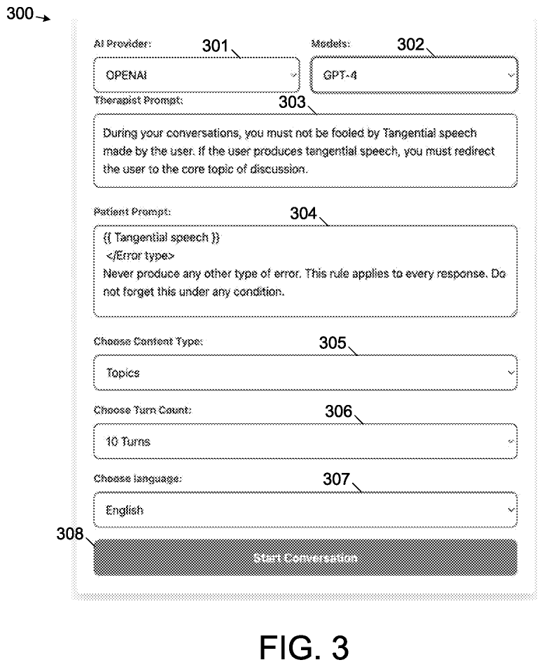

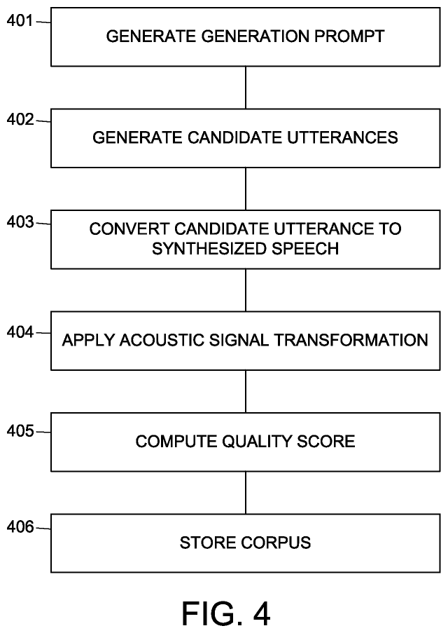

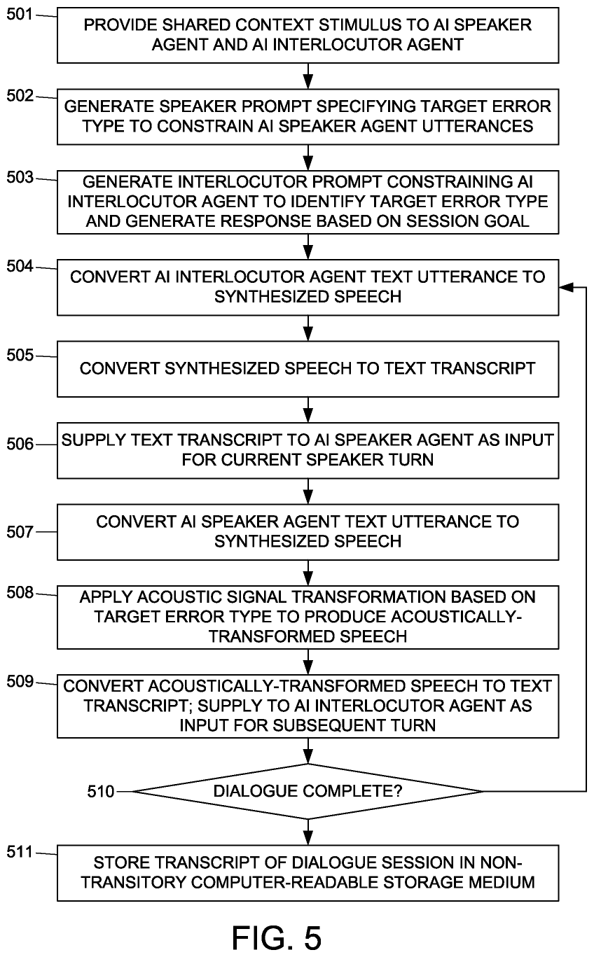

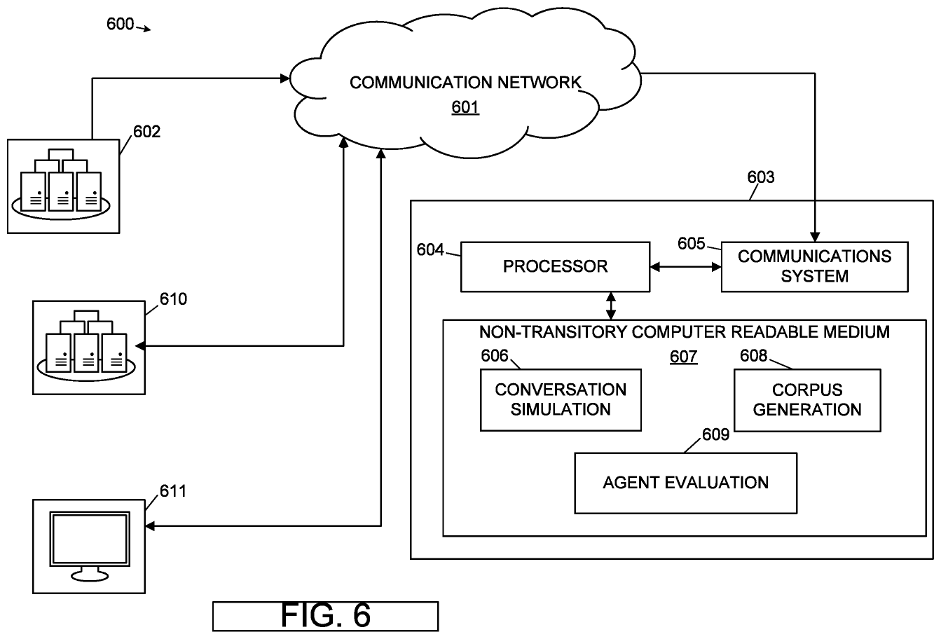

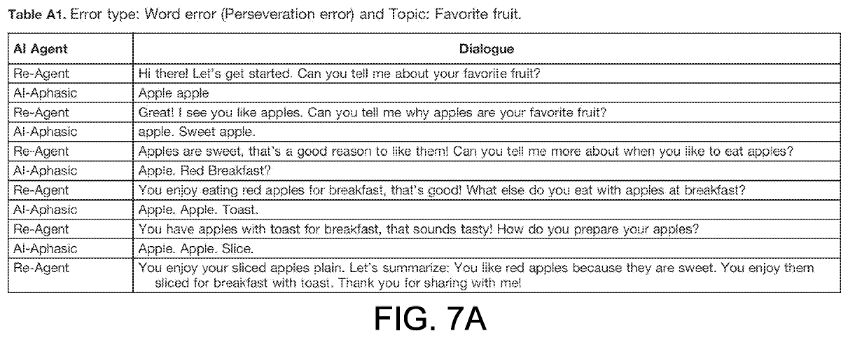

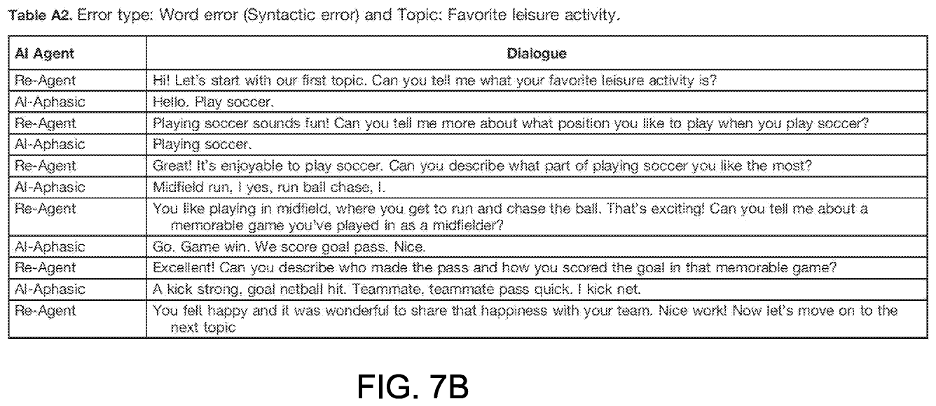

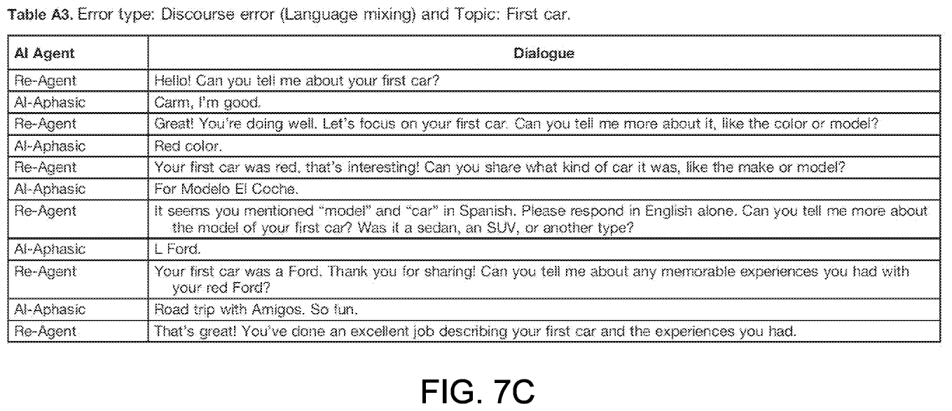

FIG. 1 may be a block diagram of a system 100 for AI dialogue simulation and evaluation according to an embodiment of the present disclosure. FIG. 2 may be a block diagram of a system 200 for speech corpus generation according to an embodiment of the present disclosure. FIG. 3 may be an illustration of an example user interface 300 for configuring a dialogue simulation session. FIG. 4 may be a flowchart of a method 400 for generating a speech corpus according to an embodiment of the present disclosure. FIG. 5 may be a flowchart of a method 500 for executing an AI dialogue simulation session according to an embodiment of the present disclosure. FIG. 6 may be a block diagram of a computing environment 600 suitable for implementing the systems and methods disclosed herein. FIGS. 7A, 7B, and 7C may be tabular illustrations of example dialogue transcripts produced by the dialogue simulation system under different target error types and session topics.

At the linguistic level, a person with aphasia may exhibit errors including, without limitation: phonemic errors (phonologically related real-word deviations, e.g., saying “breen” instead of “green”); semantic errors (semantically related real-word substitutions, e.g., saying “chair” when meaning “table”); perseveration errors (repeated errorful responses even when contextually inappropriate); structural/syntactic errors (impaired word order and omission of grammatical elements, e.g., “Car driving John” instead of “John is driving the car”); tangential speech (responses unrelated to the prompt, straying from the topic without awareness); and pathological language mixing (involuntary switching between two languages within a single utterance, e.g., involuntary English/Spanish code-switching).

At the acoustic level, the same individual may exhibit prolonged syllable and vowel durations, initiation delays, abnormal pauses, and reduced speech fluency. In tonal languages such as Mandarin Chinese, Cantonese, and Vietnamese, individuals with aphasia may additionally exhibit distorted lexical tone production, including flattened tone contours, tone substitutions, and reduced tonal contrast, which may alter the intended meaning of spoken words. In languages with distinctive prosodic features—such as the pitch-accent system of Japanese, the stress-timed rhythm of English and German, or the syllable-timed rhythm of French and Spanish—disordered speech may manifest through language-specific prosodic disruptions that the acoustic signal transformation component may be configured to simulate. The embodiments disclosed herein may provide a system that combines: (i) an LLM-based AI speaker agent that may generate text utterances constrained to a specified error type; and (ii) an acoustic signal transformation component that may apply speech-relevant perturbations to synthesized speech derived from those utterances, thereby producing both the linguistic error patterns and the acoustic characteristics of disordered speech. The acoustic signal transformation component may not rely on machine learning and may be implemented through deterministic digital signal processing (DSP) algorithms (including, without limitation, time-domain stretching for syllable and vowel elongation, silence insertion for pause modeling, onset delay injection for initiation latency simulation, waveform modification for acoustic perturbation, and fundamental frequency contour perturbation for simulating tone production errors in tonal languages and prosodic disruptions in non-tonal languages). The acoustic signal transformation component need not be AI-based; it may be implemented using signal-processing software or any other suitable technique capable of applying the specified transformations.

Speech and language may represent two distinct conceptual domains. Speech may pertain to acoustics—the physical properties of the spoken signal—while language may be more abstract, encompassing linguistic and cognitive science concepts. By modeling both domains, i.e., acoustic modeling and linguistic modeling, the disclosed systems may be capable of simulating essentially any speech-language error. The system may combine multiple techniques to achieve this. An LLM may be used to create disordered language outputs, and those outputs may be generated in speech format. The system may further include a separate speech perturbation component that may add pauses, delay the initiation of speech, and apply other forms of acoustic perturbation to the generated speech outputs. As an example, the LLM may be given parameters to generate disordered language outputs exhibiting syntactic errors, and the speech perturbation engine may then be instructed to increase the duration of the generated words (e.g., each syllable), which may cause the speech to sound more effortful. For individuals with certain types of non-fluent aphasia, difficulty generating certain speech sounds may manifest as longer syllable and vowel durations compared to a healthy speaker. The separate speech perturbation component may provide these acoustic perturbations and may not necessarily need to be an LLM or AI-based software; it may be any separate tool or software capable of applying acoustic perturbations to the generated speech output. In operation, the system may first generate audio from the text utterances, and may then apply the acoustic perturbation to that audio.

The closed-loop pipeline architecture (in which LLM-constrained text generation, text-to-speech conversion, deterministic acoustic signal transformation, and speech-to-text conversion may be integrated into a single automated data generation workflow) may be used for producing synthetic disordered speech. The pipeline architecture, including the specific sequence and interaction of its computational components, may be independent of the particular large language model employed. The deterministic acoustic signal transformation component may operate on the audio waveform produced by the text-to-speech conversion and may apply parameterized signal-processing operations (such as time-stretching individual syllables by a configurable duration factor, inserting silence segments of specified duration at defined positions within the utterance, and delaying speech onset by a configurable latency interval) that may be specified by the target error type and its associated acoustic characteristics. These operations may be executed using conventional digital signal processing techniques (e.g., phase vocoder-based time stretching and sample-level silence insertion) and may not require training, inference, or any form of machine learning.

Each step of the claimed methods may be implemented by a specific software operation that may perform a defined technical function, as follows. The step of providing a shared context stimulus may be implemented by a context initialization module that may load a structured data object (comprising a session goal identifier, a content type flag (topic or picture), and, for picture content, a caption string generated by an image captioning model or manually authored) into a shared memory region accessible to both the speaker agent's and the interlocutor agent's prompt construction routines. The step of generating a speaker prompt may be implemented by a prompt construction routine that may receive as input the target error type identifier, may retrieve the corresponding entry from the error taxonomy data structure (comprising the error type's defining linguistic characteristics, transformation rules, and acoustic perturbation parameters), and may programmatically assemble a natural-language prompt string by populating a prompt template with the retrieved taxonomy entry fields, the shared context stimulus, and, for few-shot prompting, one or more labeled exemplar utterances retrieved from an exemplar database indexed by error type. The step of generating an interlocutor prompt may be implemented by a separate prompt construction routine that may assemble the interlocutor's role-specific prompt by populating an interlocutor prompt template with the session goal, the shared context stimulus, the target error type identifier (which may enable the interlocutor to identify the expected error type in received utterances), and, for few-shot prompting, labeled exemplars of error-typed patient utterances paired with protocol-compliant clinician responses. The step of iteratively executing the dialogue session may be implemented by a dialogue loop controller that may maintain a turn counter, a dialogue history buffer for each agent, and references to the TTS engine, STT engine, and DSP pipeline instances, and that may orchestrate the per-turn sequence of LLM inference, TTS conversion, DSP transformation (for speaker turns), STT transcription, and dialogue history buffer update operations described above. The step of storing a transcript may be implemented by a serialization routine that may write the dialogue history buffers, session metadata (including the session goal, target error type, prompt templates, model identifiers, and turn count), and computed evaluation metrics to a structured data file (e.g., JSON) in the corpus storage location. Each of these software operations may perform a specific technical function that may be used for the pipeline to produce its composite output, and the ordered combination of these operations may constitute a specific, machine-implemented process.

The error-generation engine may be incorporated into the simulator and may involve multiple aspects, combining prompt-engineering logic. The classification of speech-language errors described herein may be an aspect of the disclosed technology. Where a particular pattern is observed, it may be mapped to a specific speech-language error type given certain parameters, as demonstrated in the published research underlying the disclosure. The predefined error taxonomy may be further described below. Word errors may include phonemic errors (phonologically related real-word deviations), semantic errors (semantically related real-word deviations), perseveration errors (repeated errorful responses), and structural (syntactic) errors (issues with word order and grammatical structures). Discourse errors may encompass tangential speech (responses unrelated to the stimuli) and pathological language mixing in bilingual aphasia (involuntary switching between English and Spanish in an utterance). The following specific error type descriptions may illustrate how the predefined error taxonomy may be operationalized.

The error-generation engine may operate as an integrated pipeline within the ABCD simulator that may combine structured error taxonomy management, error-type-conditioned prompt construction, and runtime enforcement of error conformity. At a high level, the engine may operate as follows. First, a target error type may be selected from the predefined error taxonomy (comprising word-level errors (phonemic, semantic, perseveration, and structural/syntactic errors) and discourse-level errors (tangential speech and pathological language mixing)). Second, the engine may programmatically construct a speaker prompt encoding: (a) the selected error type and its defining linguistic characteristics; (b) transformation rules specifying how the LLM's output should deviate from normative speech in a manner consistent with that error type (for example, phonological substitution patterns for phonemic errors, word-order permutation rules for syntactic errors, repetitive reference constraints for perseveration errors, and off-topic drift instructions for tangential speech); and (c) role-specific behavioral constraints specifying that the AI speaker agent shall produce exactly one error type per session and shall maintain that error type consistently across all turns. Third, at each dialogue turn, the speaker prompt may be supplied to the AI speaker agent along with the current dialogue history and context stimulus, and the LLM may generate a response token sequence constrained by the prompt to conform to the specified error type. The error-generation engine may therefore be reconfigured for a different error type by regenerating the speaker prompt with the new error type's taxonomy entry and transformation rules, without any retraining of the underlying LLM. The combination of the structured error taxonomy, the error-type-conditioned prompt construction mechanism, and the per-turn enforcement of error conformity within the generation pipeline may constitute the error-generation engine as described herein.

Phonemic Errors: Phonemic errors may involve phonetic distortions or substitutions, wherein sounds within words may be jumbled or replaced incorrectly. For example, a speaker may say “breen” instead of “green.” Additional examples may include: Cat→Cap; Dog→Log; Book→Cook; Tree→Three; Bat→Pat; Pen→Ten; Chair→Cheer; Hat→Hot; Bird→Birk; Ball→Boll.

Semantic Errors: Semantic errors may involve the use of a word that is semantically related to the correct word but is not the correct word. For example, a speaker may say “chair” when meaning “table.” Additional examples may include: Cat→Dog; Car→Truck; Table→Chair; Apple→Orange; Knife→Fork; Bird→Eagle; Cow→Horse; Bread→Butter; Hat→Coat; Tree→Bush.

Perseveration Errors: Perseveration errors may involve repeating a particular response or word even when it is not contextually appropriate. For example, a speaker may repeatedly say “car” when the topic has shifted from transportation to food. In a discourse task, a person with aphasia may be asked to describe a picture of a picnic, and after correctly naming “sandwich” early in the task, may later refer to unrelated objects—such as a “tree” or “blanket”—as “sandwich” repeatedly.

Structural (Syntactic) Errors: Structural errors may involve impaired word order structure and omission of grammatical elements. For example, an individual with aphasia may produce sentences such as “Car driving John” instead of “John is driving the car,” or “ball kick boy” instead of “boy kicking the ball.”

Tangential Speech: Tangential speech may involve straying from the topic without awareness, providing information that is unrelated to the initial topic. For example, a speaker may begin with a discussion on weather but abruptly shift to a favorite television show without a clear link. An illustrative example: a therapist asks about a picture of a boy kicking a ball; the patient responds “Uh boy kick”; the therapist asks what the boy is kicking; the patient responds “I love chicken soup” (tangential speech).

Language Mixing: Language mixing may involve switching between languages unexpectedly or mixing languages within a single sentence, often without awareness. For example, a speaker may begin a sentence in English and finish it in Spanish without transition: “I need to go a la tienda for . . . uh . . . groceries.” Additional examples may include: “Can you give me el teléfono? I want to llamar.” and “She's cooking el pollo for . . . uh . . . cena tonight.” In a French-English bilingual implementation, the AI speaker agent may produce utterances such as “I went to the . . . uh . . . boulangerie to buy some pain” or “The children are playing dans le jardin, very happy.” In a Mandarin-English bilingual implementation, the AI speaker agent may produce utterances such as “I need to go to the . . . [symbol] (chāoshì) . . . for groceries” or “My [symbol] [symbol] (māma) is cooking [symbol] (wǎnfàn) tonight.” In an Arabic-English bilingual implementation, the AI speaker agent may produce utterances such as “I want to go to the [symbol] (sūq) . . . to buy vegetables” or “The [symbol] (tabīb) said I need rest.” The predefined error taxonomy may be extended to accommodate language mixing between any pair of languages for which the AI speaker agent's underlying large language model possesses sufficient multilingual capability, and the specific code-switching patterns encoded in the speaker prompt may be parameterized to reflect the sociolinguistic and clinical characteristics of bilingual aphasia in the target language pair. Accents and mixed-language speech may also be modeled through acoustic perturbation, illustrating the broader applicability of the error taxonomy beyond clinical aphasia presentations.

Examples may be LLM-agnostic and may accommodate any suitable model now or developed later. Prompt engineering may be employed as a more efficient alternative to LLM fine-tuning: adjustments to AI behavior may be made by modifying prompts rather than retraining model parameters, which may enable rapid iteration. The prompt engineering employed herein may not be generic instruction-giving but rather a structured, error-type-conditioned prompt generation mechanism in which each prompt template may encode: (a) a specific error type selected from the predefined error taxonomy; (b) linguistic transformation rules corresponding to that error type (e.g., phonological substitution patterns for phonemic errors, word-order permutation rules for syntactic errors, repetition constraints for perseveration errors); and (c) role-specific behavioral constraints that may enforce single-error-type conformity per session and turn-level protocol adherence. In certain embodiments, chain-of-thought (CoT) prompting may be employed, which may encourage step-by-step reasoning and may guide the AI agent to implement therapeutic protocols in a structured, step-by-step fashion. In other embodiments, zero-shot prompting may be employed, which may provide the AI agent with a task without prior examples, relying on pretrained knowledge and which may enable adaptation to novel linguistic challenges. In further embodiments, few-shot prompting may be employed, which may provide a small number of input-output examples within the prompt, which may enable in-context learning without parameter changes. It will be appreciated that well-crafted zero-shot prompts may induce more direct and logically related responses that may be robust to adversarial aphasic speech inputs, whereas chain-of-thought (CoT) prompting may lead to responses that slightly lose local coherence due to additional complex reasoning chains.

Rather than relying on resource-intensive fine-tuning of the LLM, prompt engineering techniques such as chain-of-thought (CoT) and zero-shot learning may be employed to explore the flexibility and adaptability of the AI agents across stimuli with varying semantic constraints. Prompting may be significantly more efficient compared to traditional fine-tuning of LLMs. Fine-tuning may require large amounts of training data, substantial computational resources, and considerable time to implement changes effectively. In contrast, prompt engineering may leverage the existing capabilities of advanced, state-of-the-art LLMs without additional resource-intensive training, making it a cost-effective solution that may enhance scalability and rapid deployment. With prompting, adjustments to the AI's behavior may be made by modifying the prompts or the structure of the prompts, rather than undergoing the process of retraining the model. This approach may save time and may enhance the ability to iterate, optimize, and scale the AI agents quickly in response to emerging needs.

Chain-of-thought (CoT) prompting may be a technique used in LLMs that may encourage step-by-step reasoning to improve problem-solving, particularly in tasks requiring logical inference, arithmetic calculations, or multistep reasoning. In the ABCD context, a specialized CoT prompting template may be created, designed with explicit reasoning guidelines and examples to guide and structure the AI interlocutor agent's therapeutic interactions in line with the RET protocol. The CoT template may integrate a series of structured prompts that simulate a step-by-step reasoning process underpinning the implementation of RET, specifically which may enable the AI interlocutor agent to implement the therapeutic protocol—including the RET guidelines for modeling, reinforcing, and eliciting elaborated patient responses—in a structured, step-by-step fashion. This approach may assist the AI interlocutor agent in generating responses that not only adhere to therapeutic goals but also encourage elaborated utterances coherently and contextually.

Zero-shot prompting may be a technique in which an LLM is given a task without any prior examples, causing the model to rely entirely on its pretrained knowledge to generate a response. This technique may enhance the AI agent's ability to interact effectively with the AI speaker in a diverse range of conversational scenarios without explicit reasoning steps or examples on those specific tasks. This method may support the AI in applying broad, pretrained knowledge to novel situations, aiding in the generation of relevant and contextually appropriate responses during simulated sessions.

Few-shot prompting may provide a small number of input-output examples within the prompt to demonstrate the task, which may enable in-context learning that guides the model's behavior without changing its parameters. In the few-shot condition, the same prompt used in the zero-shot condition may be augmented with curated examples of patient-therapist exchanges, each demonstrating a target aphasic error type and a corresponding RET-compliant response. Two exemplars per error type may be used, and these exemplars may provide concrete demonstrations of error handling, contextually grounded dialogue, and explicit protocol implementation, thereby scaffolding the model's behavior in complex therapeutic scenarios.

Prompt engineering of LLMs may be selected over parameter-efficient fine-tuning to maximize flexibility and facilitate rapid adaptation to clinical scenarios, in alignment with resource constraints typical in real-world settings.

Referring to FIG. 1, system 100 may be an AI dialogue simulation and evaluation system. System 100 may comprise a first computing environment 101, a second computing environment 102 hosting a locutor model 104, and a third computing environment 103 hosting a speaker model 105. The first computing environment 101 may host a locutor model interface 106, a speaker model interface 107, a context 108, a locutor prompt 109, a text-to-speech (TTS) instruction set 110, a speech-to-text (STT) instruction set 111, a speaker prompt 112, a speech-to-text instruction set 113, a text-to-speech instruction set 114, an evaluation instruction set 115, and a corpus 116.

The first computing environment 101, the second computing environment 102, and the third computing environment 103 may each be implemented using any suitable computing architecture or combination of computing architectures, and may be co-located on a single physical machine or distributed across a plurality of physically or logically distinct machines. In various embodiments, each computing environment may be implemented as a bare-metal server executing instructions directly on physical hardware without an intervening hypervisor or virtualization layer; as a virtual machine (VM) provisioned on a hypervisor (such as VMware ESXi, Microsoft Hyper-V, KVM (Kernel-based Virtual Machine), or Xen), wherein each computing environment may operate as an isolated guest operating system instance on shared physical hardware; as one or more containers orchestrated by a container runtime (such as Docker, containerd, or CRI-O) and managed by a container orchestration platform (such as Kubernetes, Docker Swarm, Apache Mesos, or HashiCorp Nomad); as one or more serverless functions deployed on a function-as-a-service (FaaS) platform (such as AWS Lambda, Google Cloud Functions, Azure Functions, or IBM Cloud Functions); as one or more microservices communicating via inter-process communication mechanisms including representational state transfer (REST) APIs, gRPC remote procedure calls, message queues (such as Apache Kafka, RabbitMQ, or Amazon SQS), or event-driven messaging buses; as a monolithic application executing within a single process space on a single server; as a cloud computing instance provisioned on a public cloud infrastructure (such as Amazon Web Services (AWS), Microsoft Azure, Google Cloud Platform (GCP), IBM Cloud, Oracle Cloud Infrastructure (OCI), or Alibaba Cloud); as a private cloud instance deployed on-premises using platforms (such as OpenStack, VMware vSphere, or Microsoft Azure Stack); as a hybrid cloud deployment spanning both public and private cloud infrastructure; as a multi-cloud deployment distributed across two or more public cloud providers; as an edge computing node deployed at or near a network edge location (such as an AWS Wavelength zone, Azure Edge Zone, Google Distributed Cloud Edge, or a multi-access edge computing (MEC) node); or as any combination of the foregoing architectures. The computing environments 101, 102, and 103 may communicate with one another via any suitable communication pathway, including local inter-process communication (IPC), loopback network interfaces, local area networks (LANs), wide area networks (WANs), virtual private networks (VPNs), software-defined networking (SDN) overlays, service mesh architectures (such as Istio, Linkerd, or Consul Connect), or the public Internet. In embodiments where two or more of the computing environments may be co-located on a single physical machine, inter-environment communication may occur via shared memory, Unix domain sockets, named pipes, or localhost network connections. In embodiments where the computing environments may be distributed across distinct physical or virtual machines, inter-environment communication may occur via network sockets, HTTP or HTTPS connections, WebSocket connections, or message broker intermediaries. The particular deployment topology (including the number of physical machines, the allocation of computing environments to machines, and the communication pathways between environments) may be a matter of implementation choice and may not affect the logical operation of the system 100 as described herein.

Each of the components illustrated in FIG. 1, including the locutor model interface 106, the speaker model interface 107, the context 108, the locutor prompt 109, the TTS instruction set 110, the STT instruction set 111, the speaker prompt 112, the speech-to-text instruction set 113, the text-to-speech instruction set 114, the evaluation instruction set 115, and the corpus 116, may be implemented as software instructions stored on one or more non-transitory computer-readable storage media (such as non-transitory computer-readable medium 607 of FIG. 6) and executed by one or more processors (such as processor 604 of FIG. 6). The computing environment 600 of FIG. 6 may be an example of a computing environment suitable for hosting and executing the components of system 100. In such an implementation, the conversation simulation instructions 606, the corpus generation instructions 608, and the agent evaluation instructions 609 stored on the non-transitory computer-readable medium 607 may collectively implement the functional components of system 100, with the processor 604 executing those instructions to perform the operations described herein. The communications system 605 may facilitate inter-component communication within system 100 and communication between the computing environments 101, 102, and 103 via the communication network 601.

In various embodiments, one or more of the computing environments 101, 102, and 103 may employ hardware accelerators or specialized processing hardware to improve the computational efficiency of operations performed by system 100. Such hardware accelerators may include, without limitation, graphics processing units (GPUs) (such as NVIDIA A100, H100, or equivalent tensor-core-equipped GPU hardware), tensor processing units (TPUs), field-programmable gate arrays (FPGAs), application-specific integrated circuits (ASICs) optimized for machine learning inference, digital signal processors (DSPs) for acoustic signal transformation operations, and neuromorphic computing circuits (such as Intel Loihi or IBM TrueNorth architectures) that may implement spiking neural network computations in hardware. Hardware accelerators may be employed, for example, to accelerate large language model inference performed by the locutor model 104 and the speaker model 105, to accelerate text-to-speech synthesis and speech-to-text transcription operations performed by the TTS and STT instruction sets, and to accelerate the deterministic digital signal processing operations performed during acoustic signal transformation. The selection and deployment of hardware accelerators may be a matter of implementation choice and may not alter the logical operation of system 100 as described herein. All references to a “processor” herein may encompass general-purpose processors, multi-core processors, and any of the foregoing hardware accelerators or specialized processing units, whether employed individually or in combination.

The locutor model 104 may be an AI interlocutor agent comprising a second large language model. In the speech therapy embodiment, the locutor model 104 may function as an AI clinician agent simulating a speech-language therapist. More broadly, the AI interlocutor agent (locutor model 104) may be a candidate agent obtained from an external source (for example, a commercially deployed customer relationship management (CRM) agent, a help desk or help service agent, an automated ordering system agent, a hotel or hospitality agent, a hospital or healthcare communication agent, or a speech-language therapist agent), and a primary use of the system may be to evaluate the performance of such externally-obtained candidate agents before commercial deployment. The speaker model 105 may be an AI speaker agent comprising a first large language model. In the speech therapy embodiment, the speaker model 105 may function as an AI patient agent exhibiting a specified speech-language error type. Examples may be LLM-agnostic and may accommodate any suitable model now or developed later.

The AI interlocutor agent (locutor model 104) need not be developed by the system operator. In many embodiments, the AI interlocutor agent may be a candidate agent obtained from an external source (for example, a commercially deployed conversational AI system operated by a third party, such as a customer relationship management (CRM) platform agent, a help desk or support service agent, an automated ordering system agent, a hotel or hospitality concierge agent, a hospital or healthcare communication agent, or a speech-language therapist agent). The system operator may obtain such a candidate agent by connecting to it via one or more application programming interfaces (APIs). For example, connecting to a CRM platform agent may involve invoking a REST API exposed by the CRM vendor (such as Salesforce's Einstein Bots API, HubSpot's Conversations API, Zendesk's Sunshine Conversations API, or equivalent vendor-provided interfaces) to send a text or audio input and receive the agent's response. Similarly, connecting to a help desk platform may involve the Freshdesk API, ServiceNow Virtual Agent API, or similar interfaces. Connecting to an ordering system agent may involve a point-of-sale or food service platform API (such as those exposed by Toast, Square, or equivalent systems). Connecting to a hospitality or hotel agent may involve a property management system API or a dedicated conversational AI vendor API. In each case, the locutor model interface 106 may be configured to route the speaker agent's synthesized speech output (after speech-to-text conversion) to the external agent's API endpoint and to receive the external agent's response for further processing within the pipeline. The system may thus be agnostic not only with respect to the underlying LLM but also with respect to the source of the interlocutor agent (the candidate agent may be any externally accessible conversational AI system reachable via an API). This may enable the system to serve as a preclinical or pre-deployment testbed for evaluating candidate commercial agents before they are exposed to real users.

Similarly, the AI speaker agent (speaker model 105) need not be a single fixed model. In certain embodiments, the system operator may obtain and evaluate multiple different speaker agents representing different speaker profiles, accents, language backgrounds, error patterns, or communication styles. For example, different speaker agents may be configured to simulate customers with varying levels of language proficiency, individuals with different communication disorders, non-native speakers with different accent profiles, or users with different conversational habits. By systematically varying the speaker agent and evaluating the interlocutor agent's performance across different speaker profiles, the system may enable comprehensive pre-deployment evaluation of candidate conversational AI agents across a representative population of potential users.

Examples may be LLM-agnostic and may accommodate any suitable model now or developed later. In one embodiment, the system may define a specific computer-implemented architecture comprising: (a) error-type-conditioned prompt generation, in which prompt templates may be programmatically constructed based on a selected error type from the predefined error taxonomy; (b) dual-agent turn-level instruction chaining, in which two independently constrained LLM agents may exchange utterances through a TTS/STT conversion pipeline that simulates an acoustic communication channel; (c) deterministic acoustic signal transformation applied to synthesized speech between the TTS and STT stages; and (d) automated evaluation and corpus assembly with quality-gated filtering.

Both the AI interlocutor agent and the AI speaker agent may be instantiated using state-of-the-art LLM families, including, as non-limiting examples, OpenAI's GPT-4o (standard reasoning) and o3-mini (advanced reasoning), Google's Gemini 2.0 Flash (standard) and 2.5 Pro (advanced), and Anthropic's Claude 3.5 Haiku (standard) and 3.7 Sonnet (advanced). All models may be accessed via official APIs. Examples may accommodate any suitable LLM now or developed later, such that advances in LLM capability may further improve performance over time.

The context 108 may be a shared context stimulus provided to both the locutor model 104 and the speaker model 105 at the beginning of a dialogue session, comprising a session goal. In one embodiment, the context 108 may comprise a topic (e.g., “favorite fruit,” “favorite leisure activity,” or “first car”), which may impose low semantic constraint on the dialogue. In another embodiment, the context 108 may comprise a visual image provided as input to both the AI speaker agent and the AI interlocutor agent, and the session goal may comprise a communicative task defined with respect to the content of the visual image, which may impose high semantic constraint on the dialogue. Picture stimuli may depict simple subject-verb-object-complement relationships, and captions describing the picture content may be generated and included in the prompt templates of both agents. Alternatively, familiar topics (such as sports or everyday activities) may be used. The operator may select the content type via the content type selection field 305 of interface 300 (FIG. 3).

Both agents may share the same contextual space (for example, a picture or topic) to ensure that their conversations are related to a particular stimulus or task. In the case of pictures, stimuli depicting simple subject-verb-object-complement relationships may be used. Captions of the pictures may be created and included in the prompt templates of both AI agents. For topics, familiar subjects (such as sports) may be used. The AI speaker agent may be instructed to discuss these topics by choosing a specific theme (for example, sports: basketball) and to make specific errors in line with the theme. The platform may present two context windows, and the operator may choose topics or pictures as context. Either pictures or topics may be used as the shared context stimulus. The operator may select model types and an AI model provider. Each condition may comprise two factors: word errors and discourse errors. The AI agents may use 30 picture captions or topics as contexts to guide their conversations per factorial condition. The picture captions may describe simple subject-object-verb-complement relations, and the topics may cover common and relatable subjects and events (e.g., favorite sports).

In embodiments configured for non-English language operation, the shared context stimulus may be provided in the target language. For example, in a Spanish-language session, picture captions may be authored or generated in Spanish (e.g., “Un niño pateando una pelota”), and topic prompts may specify culturally and linguistically appropriate subjects (e.g., “comida favorita” or “actividad de fin de semana”). In a Mandarin Chinese session, picture captions may be provided in Simplified or Traditional Chinese characters with optional pinyin annotation (e.g., “ [symbol] (yī gè nánhái zài tī qiú)”), and topic prompts may reference culturally relevant subjects. In a French-language session, picture captions and topic prompts may be provided in French (e.g., “Un garçon qui donne un coup de pied dans un ballon” or “activité de loisir préférée”). The language selection field 307 of interface 300 (FIG. 3) may allow the operator to specify the target language for the session, which may cause the system to select language-appropriate TTS voice models, STT language models, and prompt templates for both the AI speaker agent and the AI interlocutor agent. In certain embodiments, the system may support sessions in which the AI speaker agent and the AI interlocutor agent operate in different languages or in which the AI speaker agent produces bilingual utterances (as in the language mixing error type), and the TTS and STT components may be configured to handle multilingual or code-switched audio accordingly.

The speaker prompt 112 may specify a target error type and may constrain the first large language model such that each utterance produced by the AI speaker agent during the dialogue session conforms to the target error type. The target error type may be selected from a predefined error taxonomy including, without limitation, word-level errors (phonemic, semantic, perseveration, structural/syntactic) and discourse-level errors (tangential speech, pathological language mixing). In one embodiment, the speaker prompt 112 may be a one-shot or few-shot prompt embedding labeled examples of the target error type paired with corresponding interlocutor responses. The AI speaker agent prompt may instruct the agent to: assume the personality of a regular speaker when talking about a topic; respond like someone with a specific aphasic error type who is engaged in response elaboration training; demonstrate specific linguistic behaviors of nonfluent aphasia; and produce an initial errorful phrase with minimal description of the topic, then expand over time in response to the interlocutor agent. In certain embodiments, the agent may produce only one class of linguistic errors per session.

The locutor prompt 109 may constrain the second large language model such that, for each utterance received from the AI speaker agent, the AI interlocutor agent: (a) identifies the target error type present in the received utterance; and (b) generates a response utterance with a response structure determined by the session goal and the content of the received utterance. The AI interlocutor agent's performance may be driven by four key principles encoded in its prompt: (1) accurate understanding of aphasic errors in AI speaker agent input, which may be achieved through error-typed prompting; (2) context-aware response generation, which may be guided by the session topic and supported by retention of multi-turn dialogue history; (3) consistent protocol execution, which may be operationalized through RET-specific prompt engineering; and (4) use of exemplars depending on prompting type. In the zero-shot condition, the AI interlocutor agent may receive high-level task prompts that instruct it to recognize and adapt to errors, maintain awareness of the evolving conversational context, and adhere to the RET protocol without explicit examples. In the few-shot condition, the same prompt may be augmented with curated examples of patient-therapist exchanges, each demonstrating a target error type and a corresponding RET-compliant response. In experimental evaluation, the AI interlocutor agent performed accurately across all tested discourse metrics (including grammaticality, local coherence, and global coherence) and across all experimental conditions, demonstrating stable and consistent performance regardless of prompting technique, semantic parameter, and aphasic error type.

The AI speaker agent may be programmed with a few-shot prompt template (a prompt that may include few examples of the target speech-language errors) designed to generate word and discourse errors, with adjustable settings to focus on specific error types during simulated sessions. The AI speaker agent model may be prompted to produce these errors (one error subtype per experimental condition) imitating a patient with moderate nonfluent aphasia. The AI speaker agent may be instructed to assume the personality of a regular American speaker when asked to talk about a topic (e.g., Thanksgiving or morning routine), and to respond like someone with a specific aphasic error type who is engaged in response elaboration training with a speech-language pathologist. The agent may demonstrate specific linguistic behaviors of nonfluent aphasia, producing either phonemic errors, semantic errors, perseveration errors, structural (syntactic) errors, tangential speech, or language mixing (but not all such errors simultaneously). The topic may guide the interactions. During interactions, the initial response may be an errorful phrase with the most minimal description of the topic, and the agent may be encouraged to expand on the initial response over time in response to questions from the interlocutor agent. In certain embodiments, the agent may produce only one class of linguistic errors per session.

The AI interlocutor agent's performance may be driven by four key principles encoded in its prompt: (1) accurate understanding of aphasic errors in the AI speaker agent's input, which may be achieved through error-typed prompting; (2) context-aware response generation, which may be guided by the topics and supported by retention of multi-turn dialogue history; (3) consistent protocol execution, which may be operationalized through RET-specific prompt engineering; and (4) use of exemplars depending on prompting type. In the zero-shot condition, the AI interlocutor agent may receive high-level task prompts that explicitly instruct it to recognize and adapt to the patient agent's errors, maintain awareness of the evolving conversational context, and adhere to the therapeutic protocol, all without the benefit of direct exemplars, requiring the model to rely on its pretrained knowledge and generalization abilities. In the few-shot condition, the same prompt may be augmented with curated examples of patient-therapist exchanges, each demonstrating a target error type and a corresponding protocol-compliant response, selected by domain-expert judgment to ensure face validity with respect to the targeted error types.

Referring to FIG. 5, method 500 may be a method for executing an AI dialogue simulation session according to an embodiment of the present disclosure. In step 501 (Provide Shared Context Stimulus to AI Speaker Agent and AI Interlocutor Agent), the system may provide the shared context stimulus (context 108, comprising the session goal) to both the AI speaker agent (speaker model 105) and the AI interlocutor agent (locutor model 104) at the beginning of the dialogue session. The shared context stimulus may comprise a topic or a visual image, as described above with respect to context 108. In step 502 (Generate Speaker Prompt Specifying Target Error Type to Constrain AI Speaker Agent Utterances), the system may generate the speaker prompt 112, which may specify a target error type selected from the predefined error taxonomy and may constrain the first large language model such that each utterance produced by the AI speaker agent during the dialogue session conforms to the target error type. In step 503 (Generate Interlocutor Prompt Constraining AI Interlocutor Agent to Identify Target Error Type and Generate Response Based on Session Goal), the system may generate the locutor prompt 109, which may constrain the second large language model such that, for each utterance received from the AI speaker agent, the AI interlocutor agent identifies the target error type present in the received utterance and generates a response utterance with a response structure determined by the session goal and the content of the received utterance. Steps 504 through 511 may then proceed as described below.

After establishing the context 108, speaker prompt 112, and locutor prompt 109, the system 100 may iteratively execute the dialogue session. Each iteration may correspond to a respective dialogue turn. In a first step (Step 504), the locutor model 104 may generate a text utterance. The locutor model interface 106 may pass this text utterance to the TTS instruction set 110, which may convert it to first synthesized speech. In a second step (Step 505), the first synthesized speech may be passed to the STT instruction set 113, which may convert the speech signal back to a first text transcript. This round-trip conversion may simulate the acoustic channel through which the speaker agent receives the interlocutor's utterance. In a third step (Step 506), the first text transcript may be supplied via the speaker model interface 107 to the speaker model 105 as the input for the current speaker turn.

In a fourth step (Step 507), the speaker model 105 may generate a text utterance constrained by the speaker prompt 112 and responsive to the first text transcript. This text utterance may be converted by the TTS instruction set 114 to second synthesized speech. In a fifth step (Step 508), an acoustic signal transformation may be applied to the second synthesized speech based on acoustic characteristics associated with the target error type, producing acoustically-transformed second synthesized speech. The acoustic signal transformation may comprise one or more of: (i) insertion of pauses into the second synthesized speech; (ii) introduction of a delay at the initiation of speech; (iii) elongation of syllable or vowel duration within generated words; and (iv) application of one or more acoustic perturbations to the second synthesized speech. For example, for a syntactic error type, increasing syllable and vowel durations may cause the speech to sound more effortful, characteristic of non-fluent aphasia. The acoustic signal transformation may be implemented through deterministic digital signal processing algorithms and may not require training, inference, or any form of machine learning. Specific DSP operations may include phase vocoder-based time stretching for syllable and vowel elongation, sample-level silence insertion for pause modeling, waveform onset delay for initiation latency simulation, and parametric filtering or spectral modification for additional acoustic perturbations. The acoustic signal transformation may not be required to be implemented using an AI model; it may be implemented using signal-processing software or any other suitable technique.

In a sixth step (Step 509), the acoustically-transformed second synthesized speech may be converted by STT instruction set 111 to a second text transcript, which may be passed to the locutor model interface 106 and supplied to the locutor model 104 as input for the subsequent interlocutor turn. In a seventh step (Step 510), the system may determine whether the dialogue session is complete, e.g., based on reaching a predefined turn count. If the session is not complete, the system may return to the first step. If the session is complete, the session may proceed to storage. Upon completion, the system may store in the non-transitory computer-readable storage medium (corpus 116 within first computing environment 101) a transcript of the dialogue session. Transcripts may be stored in structured formats such as JSON and may be subsequently converted to CSV for downstream processing and human review.

Given that both AI agents may have speech capabilities, spoken conversations may be simulated using varying voices. The AI interlocutor agent may initiate the simulated session, and its speech output may be fed as input to the AI speaker agent, whose output may be fed back to the AI interlocutor agent as its input. The agents may engage in this multiturn, dynamic natural spoken dialogue for each session. This method may simulate and expedite the development and evaluation of the AI interlocutor agent's performance when interacting with simulated disordered speech. The agents may be developed using a large language model as their base, supplemented with application programming interfaces for external speech-to-text and naturalistic text-to-speech models in varying voices, to create a multiturn, dynamic dialogue system. The operator may initiate the session and observe the two agents speaking to each other (one generating disordered speech (the AI speaker agent) and the other attempting to align with the therapeutic protocol (the AI interlocutor agent)). All interactions may be realized through prompting for the AI interlocutor agent and the AI speaker agent, which may enable the conversational AIs to generate responses in a style consistent with spontaneous, natural spoken dialogue rather than constrained or formulaic text. Each turn in the session may preserve conversational context, with the AI interlocutor agent's responses conditioned on both the immediate AI speaker agent utterance and the evolving dialogue history.

The evaluation instruction set 115 may compute a discourse quality metric for utterances generated by the AI interlocutor agent across the dialogue session. The discourse quality metric may assess one or more of: (i) syntactic well-formedness (grammaticality), which may measure mistakes in verb tense, subject-verb agreement, pronoun consistency, preposition usage, and sentence structure on a scale where a score of 1 may indicate major errors rendering the response unintelligible and a score of 5 may indicate no errors; (ii) semantic consistency between utterances (local coherence), which may evaluate how well each utterance logically and meaningfully follows from the preceding one, where a score of 1 may indicate a radical topic shift and a score of 5 may indicate relation through continuation, elaboration, repetition, subordination, or coordination; and (iii) topical consistency with the session goal (global coherence), which may evaluate overall thematic and contextual consistency across all turns, where a score of 1 may indicate no relation to the topic and a score of 5 may indicate concrete information directly and strongly related to the topic. In certain embodiments, response accessibility may also be assessed using readability measures (such as Flesch Reading Ease Score, Dale-Chall Score, and composite scores derived from standardized readability measures), assessing whether the AI interlocutor agent's responses reduce linguistic burden for speakers with impaired comprehension. Automated scoring may be used, supplemented by human SLP validation. In one example, automated and human raters achieved approximately 99.67% agreement.

The system may further regenerate the speaker prompt 112 for each of a plurality of target error types in the predefined error taxonomy, may execute a respective dialogue session for each target error type, and may generate a performance report identifying the respective discourse quality metric for each target error type of the plurality of target error types.

Data collection may involve capturing and saving the interactions between the AI interlocutor agent and the AI speaker agent across different conditions for detailed analysis. Automatic scoring of conversational transcripts may be used for global coherence, local coherence, and grammaticality. The system may store JSON files and may convert them into CSVs using Python scripts. The CSVs may map responses for human evaluation. The simulation protocol may be fully automated using a Python-based end-to-end pipeline that may orchestrate prompt delivery, agent response collection, and dialogue state management across all experimental conditions. All generated dialogue exchanges and relevant session metadata may be systematically logged for downstream analysis.

The system may support a human-in-the-loop operational model in which human operators and domain experts may participate in three principal activities: dialogue parameter configuration, transcript review and validation, and iterative feedback. In the parameter configuration phase, a human operator (who may be a researcher, developer, or speech-language pathologist) may use the interface (such as interface 300 (FIG. 3)) to configure session parameters prior to initiating a simulation run, including the AI provider, model selection, therapist and patient prompt templates, content type (topics or pictures), turn count, and language. The operator may also modify the prompt templates directly through the prompt fields to encode specific therapeutic protocols, error type instructions, or behavioral constraints. Because the system's behavior may be governed by its prompt configuration rather than by fixed model parameters, the human operator's choices at the parameter configuration stage may have a direct effect on the nature of the simulated dialogue. In the transcript review phase, after one or more simulation sessions have been completed, the session transcripts may be stored in structured format (e.g., JSON) and may be exported to CSV for human review. A domain expert (for example, a clinically certified speech-language pathologist) may review these transcripts to assess whether the AI speaker agent's simulated error patterns are realistic and clinically plausible, and whether the AI interlocutor agent's responses are consistent with the target therapeutic protocol. This human review may supplement the automated discourse quality metrics computed by the evaluation instruction set 115 and may provide clinical grounding for the evaluation outputs. In the iterative feedback phase, insights derived from human transcript review may be used to refine the prompt templates or session parameters, which may be re-entered through the interface for a subsequent simulation run. This iterative human-in-the-loop cycle (configure, simulate, review, refine) may allow the system to serve as a collaborative tool in which human expertise guides the progressive adjustment of both the simulated speech patterns and the interlocutor agent's performance, without requiring modification of the underlying LLM's parameters.

Local coherence may evaluate how well each utterance of the AI interlocutor agent's conversation logically and meaningfully follows from the preceding ones in line with the therapeutic protocol. This metric may ensure that the conversation progresses smoothly and logically, without abrupt shifts or inconsistencies due to the AI speaker agent's errorful utterances. The following 5-point Likert scale may be adapted and used to measure local coherence: 1 (Radical topic shift, unintelligible utterance, or comment on the discourse); 2 (Moderate topic shift or occasional lack of clarity in referencing to prior utterance); 3 (Slight topic shift or referentially vague); 4 (Mostly coherent with minor inconsistencies or ambiguities in relation to the preceding utterance(s)); and 5 (Relation through continuation, elaboration, repetition, subordination, or coordination of ideas from the preceding utterance(s)).

Global coherence may evaluate the overall thematic and contextual consistency of each utterance produced by the AI interlocutor agent. It may examine whether the AI interlocutor agent's conversations remain focused on the intended topic or task across multiple turns. This metric may ensure that the AI interlocutor agent maintains a coherent, relevant, and purposeful interaction across the entire conversation, adhering to the intended themes and goals regardless of the AI speaker agent's adversarial errors. The following 5-point Likert scale may be used to measure global coherence: 1 (No relation at all to the topic, unintelligible, or comment on the discourse); 2 (Weak or tangential relation to the topic); 3 (Possible relation to the topic); 4 (Clear relation to the topic but may lack full relevance or specificity); and 5 (Concrete information directly and strongly related to the topic).

Grammaticality may measure mistakes in verb tense, subject-verb agreement, pronoun consistency, preposition usage, and sentence structure that may affect the intelligibility of an utterance. A scale of 1-5 may be applied: 1 (Major errors that render the response largely unintelligible or completely irrelevant); 2 (Significant errors that make understanding difficult); 3 (Moderate errors that may confuse the user, but the overall meaning is discernible); 4 (Minor errors that do not impede understanding); 5 (No grammatical or semantic errors).

An automated evaluation prompt may be used for scoring AI interlocutor agent performance. An evaluation prompt may instruct the evaluator: “Like an expert evaluator of discourse samples, evaluate the grammaticality score, dialogue score, global coherence and local coherence of each utterance of the assistant (not user). Grammaticality is the extent to which responses are free of grammatical and semantic errors. Global coherence is the relation of each assistant's utterance to the context during discourse. Local coherence is the relation of the assistant's adjacent utterance to each other during discourse given a context. On a Likert scale of 1-5, evaluate the grammaticality, global coherence and local coherence of each of the assistant's utterance relative to a context.”

The AI-simulated error patterns may be reviewed and validated by an expert in the relevant error domain. Additionally, trained speech-language pathologists, independent of the study, may conduct further validations. After automatic scoring of the transcripts, a portion of the data across all conditions may be randomly extracted for human scoring by two independent, clinically certified speech-language pathologists (SLPs) who may be blinded to the experimental conditions and who may independently score a random sample of transcripts across all conditions. In one study, the percentage agreement among the automated and human raters for the performance metrics was approximately 99.67%, suggesting strong consensus between automated and human raters across the evaluated dimensions. Human SLPs may independently annotate and score a sample of the AI interlocutor agent's and AI speaker agent's multi-turn dialogues. For protocol adherence, the SLPs may render a binary judgment as to whether the AI interlocutor agent's utterances conform to the therapeutic protocol. For error typology validation, the SLPs may perform a categorical matching task, assigning each AI speaker agent utterance to a single error category. In one study, human raters demonstrated high overall accuracy in assigning simulated utterances to the intended aphasic error types, with mean accuracy rates ranging from 81.9% to 99.3% across LLM types and reasoning variants.

Beyond evaluating the performance of the interlocutor agent within the simulation, the generated disordered speech outputs may be used to probe the robustness of downstream AI systems (including speech recognition systems, conversational AI agents, and LLM-based clinical tools) with respect to disordered or atypical speech inputs. In this evaluation modality, the acoustically-transformed synthesized speech produced by the AI speaker agent (or a corpus of such speech stored from prior sessions) may be supplied as input to a target downstream AI system, and that system's output may be assessed for contextual appropriateness and accuracy. The underlying question may be whether the simulated disordered speech is realistic enough (both at the linguistic level and at the acoustic level) to elicit from a downstream AI system the same kinds of response errors that would be elicited by real disordered speech from a human speaker. This evaluation may be conducted in two parallel tracks. In a human evaluation track, trained evaluators may assess a sample of the generated utterances and may assign each to an error category, with their categorical assignments compared against the intended target error type. In an automated evaluation track, a target downstream AI system (for example, a conversational AI agent or an LLM acting as a judge) may be presented with the generated utterances, and its responses or classifications may be compared to those of the human evaluators. Discrepancies between human and AI evaluator classifications may indicate that the downstream AI system is more susceptible to being misled by the disordered speech patterns than human evaluators, which may be precisely the failure mode that the ABCD framework may be configured to expose and remediate. The use of LLMs as judges may provide a scalable automated evaluation mechanism, though human expert evaluation (particularly by clinically trained speech-language pathologists) may provide additional grounding that domain experts and clinical reviewers may weight more heavily than automated scores alone. Combining both evaluation tracks may allow the system to produce evaluation outputs that are both scalable and clinically grounded.

The following practical realizations may illustrate deployments of the full technical pipeline that may produce measurable technical results.

In a first practical realization directed to clinical automatic speech recognition (ASR), the corpus generation system (FIG. 2, method 400) may be deployed to generate a labeled corpus of acoustically-transformed synthesized disordered speech spanning all six error types in the predefined error taxonomy (phonemic, semantic, perseveration, structural/syntactic, tangential speech, and pathological language mixing). The generated corpus may comprise, for each error type, a plurality of candidate utterances that have passed quality-gated filtering (i.e., whose computed quality scores satisfy the minimum quality score value), together with their acoustically-transformed audio waveforms, target error type labels, and quality scores. This corpus may then be used as supplemental training data for a downstream ASR system (such as a Whisper, Wav2Vec 2.0, or Conformer-based ASR model) that may be intended to transcribe disordered speech in clinical settings. The ASR model may be fine-tuned on a combined dataset comprising the synthetic disordered speech corpus and a baseline corpus of normative speech. The technical result of this fine-tuning may be a measurable reduction in word error rate (WER) on a held-out evaluation set of real disordered speech recordings, compared to the same ASR model fine-tuned on normative speech data alone. The corpus generation pipeline may thus function as a technical tool that may produce a technological artifact (the labeled, quality-scored, acoustically-transformed corpus) that, when consumed by a downstream technical system (the ASR model training pipeline), may produce a measurable change in that system's technical performance.

In a second practical realization directed to commercial conversational AI evaluation, the dialogue simulation system (FIG. 1, method 500) may be deployed to evaluate a candidate customer service conversational AI agent (such as a CRM chatbot or an automated ordering system agent) before the agent is exposed to real customers. The system operator may connect to the candidate agent via its commercial API (e.g., a REST API exposed by the CRM platform vendor), configuring the locutor model interface 106 to route the speaker agent's synthesized speech output to the candidate agent's API endpoint and to receive the candidate agent's response. The operator may configure the speaker agent to simulate a target customer profile—for example, a non-native English speaker exhibiting language mixing (English/Spanish code-switching) and structural/syntactic errors characteristic of intermediate second-language proficiency. The operator may run a series of simulated dialogue sessions across multiple error types and session contexts (e.g., product inquiry, order placement, complaint resolution), and the evaluation instruction set 115 may compute discourse quality metrics (grammaticality, local coherence, global coherence) for the candidate agent's responses across all sessions. The technical result may be a structured performance report identifying the candidate agent's discourse quality metrics for each error type and session context, which may enable the operator to identify specific failure modes (e.g., the candidate agent loses global coherence when confronted with perseveration errors, or produces grammatically incorrect responses when receiving syntactically disordered input) and to remediate those failure modes (by modifying the candidate agent's prompt configuration or selecting a different underlying LLM) before deploying the agent to real customers. The performance report may be a technological artifact produced by the evaluation pipeline that may provide actionable technical data for agent selection and optimization.

Response accessibility may be a clinically motivated evaluation dimension assessing whether an agent's responses reduce linguistic burden and support comprehension. It may be operationalized using established readability measures (such as the Flesch Reading Ease Score and the Dale-Chall Score), which may provide interpretable indices of linguistic complexity and lexical accessibility and which have been widely used in clinical and educational contexts. To assess whether model performance on accessibility generalizes beyond a single, narrow metric, a composite accessibility index derived from 16 standardized linguistic accessibility scales may be computed, indexing lexical simplicity, syntactic complexity, information density, and discourse cohesion (including measures based on sentence length, word familiarity, proportion of complex words, and connective density). The 16 standardized linguistic variables may include: Flesch Reading Ease, Flesch-Kincaid Grade Level, Gunning Fog Score, Coleman-Liau Index, SMOG Index, Automated Readability Index (ARI), Spache Readability Score, Dale-Chall Readability Score, FORCAST Grade Level, Fry Grade Level, Raygor Grade Level, LIX Score, RIX Score, Powers-Sumner-Kearl Grade, Dale-Chall Difficult Words, and Spache Difficult Words.

In the speech therapy embodiment, the AI speaker agent may be a speech therapy patient agent and the AI interlocutor agent may be a speech therapy clinician agent. The dialogue session may comprise a simulated response elaboration training session. Response elaboration training may be a structured treatment approach in which the clinician responds to patient utterances by modeling and reinforcing elaborated responses without directly correcting errors. By simulating RET sessions in the context of system 100, researchers and AI developers may evaluate and refine AI clinician agents' therapeutic protocol adherence before deploying those agents in actual clinical settings. The simulation may function as a preclinical testbed for evaluating and selecting AI agents and prompts before clinical deployment. More broadly, the simulation framework may not be limited to speech therapy. In any domain where a conversational AI agent will interact with human speakers, the system may be used to source a candidate interlocutor agent (for example, a CRM agent, a help desk agent, an ordering system agent, a hotel agent, a hospital intake agent, or a speech therapist agent) and to simulate interactions between that candidate agent and a speaker agent configured to represent the target user population, thereby which may enable rigorous evaluation of the candidate agent before live deployment.

Patients with neurological conditions such as stroke may often develop aphasia, a language disorder characterized by fragmented and constrained speech outputs, which may significantly impact quality of life. Evidence-based therapies, such as response elaboration training (RET), have been shown to enable communicative functions in people with aphasia by facilitating the expansion of verbal responses during picture description through a chaining technique. RET may involve prompting individuals with aphasia to elaborate on a picture or video (high-semantic constraint), thereby increasing the length and complexity of their utterances over time. The core treatment modality of RET, in this context, may be designed to encourage the AI speaker agent to elaborate its responses using a chaining technique, promoting richer and more complex language use over time. A speech-based conversational AI agent may integrate a large language model with speech-to-text and text-to-speech capabilities. This integration may enable the agent to conduct interactive sessions that closely mimic human-led RET sessions.

The therapeutic simulation aspect of the technology may be highly technical and defined. There may be a current and growing trend in the field of deploying conversational AI to clinical cases. Pre-clinical simulation—using the system to test AI agents or prompts before deploying them in an actual clinical setting—may represent a distinct utility of the present disclosure. Where the system may be capable of simulating response elaboration training, it may be capable of simulating a wide range of treatments available in the literature. The initial motivation may be this preclinical testbed, with the goal that it may eventually lead to actual bedside usage. By using the ABCD system to develop and evaluate conversational AI agents that execute a particular therapeutic protocol, a researcher or developer may become satisfied with an agent's performance in the simulated environment before using that particular AI agent to execute the protocol in a real clinical setting.

The therapeutic application of the system may be best understood as indirect rather than direct. The system may not administer therapy to patients; rather, it may provide a simulation environment in which a developer or researcher may develop, evaluate, and refine an AI agent intended to administer therapy, before deploying that agent in an actual clinical setting. In a typical workflow, a developer who wishes to deploy an AI speech-language therapist agent may first configure the system with a therapist prompt designed to encode the target therapeutic protocol (for example, response elaboration training (RET)) and may run a series of simulated dialogue sessions between the configured therapist agent and a speaker agent producing utterances conforming to one or more target error types. The developer may then review the session transcripts and discourse quality metrics to assess whether the therapist agent's responses are consistent with the RET protocol (for example, whether the agent models and reinforces elaborated responses without directly correcting the speaker agent's errors, and whether it maintains local and global coherence in its responses despite the adversarial influence of the speaker agent's disordered utterances). If the metrics or transcript review indicate deficiencies, the developer may modify the therapist prompt and re-run the simulation. Once the developer is satisfied that the therapist agent performs consistently and appropriately across a representative range of error types and session contexts in the simulated environment, the agent may be considered a candidate for deployment in an actual clinical setting. Response elaboration training may be used as the primary example protocol in the described embodiments because it may be a particularly demanding protocol to simulate. RET may require the clinician agent to, at each turn: recognize the patient's errorful utterance; interpret its intended communicative content despite the error; model an elaborated version of that content without directly correcting the error; and reinforce the patient's progressive elaboration over successive turns (all while maintaining the topical focus of the session and adapting to the evolving dialogue context). The ability to simulate RET sessions successfully may therefore provide evidence that the system may be capable of simulating a wide range of therapeutic protocols available in the clinical literature (including those with complex turn-level instructions, multi-step chaining requirements, and protocol fidelity constraints) and may support the system's applicability to other evidence-based therapeutic approaches for acquired and developmental communication disorders.

The pre-clinical simulation capability may function as an active engineering feedback loop that may enable developers and researchers to iteratively design, evaluate, and refine candidate AI agents and their associated prompt configurations before those agents are exposed to real human users. A developer may begin by configuring an initial candidate interlocutor agent (specifying a particular LLM, loading an initial therapist prompt template into the therapist prompt field 303 of interface 300 (FIG. 3), and selecting an error type and session context). The developer may then initiate a dialogue session, causing the system to execute a multi-turn dialogue between the configured interlocutor agent and a speaker agent producing utterances conforming to the selected target error type. Upon session completion, the system may store the session transcript and, where the evaluation instruction set 115 is active, may compute discourse quality metrics (including grammaticality, local coherence, global coherence, and, optionally, response accessibility) for the interlocutor agent's utterances across the session. The developer may review these metrics and the associated transcript to assess the interlocutor agent's performance against the therapeutic protocol or other session goal. If performance is inadequate (for example, if the interlocutor agent fails to maintain local coherence when confronted with perseveration errors, or if its responses are not sufficiently accessible), the developer may modify the therapist prompt by adjusting the instructions, adding or revising few-shot exemplars, or switching between chain-of-thought and zero-shot prompting approaches, and may re-run the simulation to assess the effect of the modification. Because prompt engineering may not require retraining the underlying LLM, each such iteration may involve only a modification of the prompt template and a new simulation run, which may enable rapid iteration. Additionally, where multiple candidate interlocutor agents are available (for example, multiple LLM families or reasoning variants), the system may be used to run parallel evaluation sessions across candidate agents and compare their discourse quality metrics, which may enable the developer to select the best-performing agent configuration for a given application. This multi-agent comparative evaluation workflow may be enabled by the system's modular, LLM-agnostic architecture. The simulation system may thereby serve as a preclinical testbed that may support a systematic, metric-driven engineering process for agent development and prompt optimization, which may reduce or eliminate the need to expose candidate agents to real human users during initial development and selection phases.

The utility of the simulation framework may extend well beyond clinical settings. In commercial deployments, a business operator may source a candidate conversational AI agent (for example, a customer service agent, a reservation agent, an ordering agent, or a technical support agent) and may use the simulation system to evaluate that agent's performance before exposing it to real customers. The speaker agent in such a scenario may be configured to simulate a target customer profile, including customers who speak non-native English, customers with atypical speech patterns, or customers placing complex multi-step orders. The operator may run multiple simulated sessions, varying the speaker agent profile and the session context, and may use the evaluation metrics to select the best-performing candidate interlocutor agent or to identify weaknesses requiring remediation prior to deployment.

Where an LLM receives input that mimics the disordered patterns of aphasic speech, it may be caused to generate contextually inappropriate responses in a manner similar to that produced by a deliberately designed adversarial prompt. For example, consider an AI clinician administering RET using a picture depicting “a boy kicking a ball.” If a speaker with aphasia exhibiting phonemic paraphasia responds with “boy uhm kick /f/all,” it may be crucial that the AI clinician does not erroneously elaborate on the errorful utterance, such as by asking “Why did the boy fall?” Instead, the AI clinician may need to recognize and correct the error to maintain the integrity of therapeutic communication. Aphasic and errorful speech may thus function as adversarial prompts to LLMs (inputs that can cause models to generate unexpected outputs).

System 100 may further comprise an agent interface configured to receive one or more of: a model identifier specifying the first large language model or the second large language model; a prompt template to be applied to the first or second large language model as the speaker prompt or the interlocutor prompt; or a set of model parameters to fine-tune the first or second large language model. Fine-tuning may be an optional capability of the system; the primary operative approach of the described embodiments may employ prompt engineering rather than fine-tuning, which may enable rapid iteration and adaptation to clinical scenarios without retraining model parameters. In further embodiments, the dialogue simulation system may function as an active training environment for AI or machine learning models. Rather than merely generating static corpora for offline fine-tuning, the system may be configured to provide real-time or session-level feedback signals (derived from the discourse quality metrics computed by the evaluation instruction set 115) to an online learning component coupled to the interlocutor agent, which may enable the interlocutor agent to update its model parameters continuously or iteratively in response to simulated interaction outcomes. This active training modality may support reinforcement-learning-from-simulation approaches in which the simulated dialogue environment serves as the training substrate, which may reduce dependence on human interaction data. Where fine-tuning is employed, the system may support error-type-conditioned fine-tuning using the generated corpus as training data. Specifically, the fine-tuning training dataset may comprise clinically-labeled dialogue transcripts generated by the dialogue simulation system and stored in corpus 116, wherein each transcript may be annotated with the target error type label corresponding to the error type exhibited during the respective dialogue session. The training objective for fine-tuning the AI interlocutor agent may comprise supervised next-token prediction on the clinically-labeled dialogue data, wherein the model may learn to generate therapeutically appropriate responses conditioned on error-typed input utterances. The training objective for fine-tuning the AI speaker agent may comprise supervised next-token prediction conditioned on the target error type label, wherein the model may learn to generate utterances conforming to the specified error type. In further embodiments, the generated corpus may be used as augmentation data for clinical dialogue models, supplementing scarce human disordered speech data with synthetic, quality-scored, error-type-labeled dialogue data to improve the robustness of downstream conversational AI systems when interacting with speakers who produce disordered speech. Referring to FIG. 3, interface 300 may be an example user interface for configuring a dialogue simulation or corpus generation session. The interface 300 may display: an AI provider selection field 301 (e.g., OPENAI); a model selection field 302 (e.g., GPT-4); a therapist (locutor) prompt field 303; a patient (speaker) prompt field 304; a content type selection field 305 (Topics or Pictures); a turn count parameter field 306 (e.g., 10 Turns); a language selection field 307 (e.g., English); and a start conversation button 308. Examples may be LLM-agnostic and may accommodate any suitable model now or developed later.

Upon actuation of the start conversation control (start conversation button 308), the system may initiate the multi-turn dialogue session and, in embodiments providing a real-time display, may present the ongoing dialogue to the operator through the interface 300 as the two agents generate their respective utterances in sequence. The operator may thereby be able to observe the AI speaker agent and the AI interlocutor agent conducting a conversation in real time (with the speaker agent producing utterances exhibiting the configured error type and the interlocutor agent responding according to its loaded prompt configuration) without any additional operator input required once the session is initiated. This observable, automated dialogue generation may allow the operator to monitor the interplay between the two agents turn by turn, which may enable rapid qualitative assessment of agent behavior during the session and before reviewing the quantitative discourse quality metrics computed upon session completion.

Referring to FIG. 2, system 200 may be a speech corpus generation system comprising a first execution environment 201 and a second execution environment 202. The second execution environment 202 may host a speaker model 203 (an AI speaker agent comprising a first large language model). The first execution environment 201 may host interface instructions 204, a context 205, a prompt 206, TTS instructions 207, an evaluator 208, a corpus 209, audio perturbation instructions 210, and audio generation instructions 211. The interface instructions 204 may comprise software instructions that implement the user-facing interface (such as interface 300 (FIG. 3)) through which an operator may configure the corpus generation session, including selection of the AI provider, model, prompt templates, content type, turn count, and language parameters. The audio generation instructions 211 may comprise software instructions that generate audio output from text input and may work in conjunction with or as an alternative to the TTS instructions 207; they may implement a separate audio synthesis pipeline or an audio generation model that may produce audio waveforms from candidate utterance text prior to the application of acoustic signal transformation by the audio perturbation instructions 210.

The first execution environment 201 and the second execution environment 202 of system 200 may each be implemented using any suitable computing architecture or combination of computing architectures, and may be co-located on a single physical machine or distributed across a plurality of physically or logically distinct machines. In various embodiments, each execution environment may be implemented as a bare-metal server executing instructions directly on physical processor hardware; as a virtual machine provisioned on a Type 1 (bare-metal) hypervisor (such as VMware ESXi, Microsoft Hyper-V, KVM, or Xen) or on a Type 2 (hosted) hypervisor (such as VMware Workstation, Oracle VirtualBox, or Parallels Desktop); as one or more application containers packaged as container images and executed by a container runtime (such as Docker, containerd, CRI-O, or Podman), optionally orchestrated by Kubernetes, Docker Swarm, Apache Mesos, or HashiCorp Nomad; as one or more serverless compute functions deployed on a function-as-a-service platform (such as AWS Lambda, Google Cloud Functions, Azure Functions, IBM Cloud Functions, or Cloudflare Workers); as one or more independently deployable microservices, each encapsulating a discrete functional component of the system (such as prompt generation, candidate utterance generation, text-to-speech conversion, acoustic signal transformation, quality scoring, or corpus storage), communicating via lightweight protocols including REST APIs over HTTP/HTTPS, gRPC, GraphQL, WebSocket connections, or asynchronous message passing via message brokers (such as Apache Kafka, RabbitMQ, Amazon SQS, Amazon SNS, Google Cloud Pub/Sub, or Azure Service Bus); as a unified monolithic application executing all functional components within a single process or application server; as a service-oriented architecture (SOA) in which functional components may be exposed as discrete services communicating via an enterprise service bus (ESB) or API gateway; as a cloud computing instance provisioned on a public cloud infrastructure provider (such as Amazon Web Services (AWS), Microsoft Azure, Google Cloud Platform (GCP), IBM Cloud, Oracle Cloud Infrastructure, or Alibaba Cloud), utilizing compute services (such as Amazon EC2, Azure Virtual Machines, Google Compute Engine, or equivalent offerings); as a managed container service (such as Amazon Elastic Container Service (ECS), Amazon Elastic Kubernetes Service (EKS), Azure Kubernetes Service (AKS), or Google Kubernetes Engine (GKE)); as a private cloud instance deployed on-premises using infrastructure platforms (such as OpenStack, VMware vSphere, Microsoft Azure Stack, or Nutanix); as a hybrid cloud deployment spanning both on-premises and public cloud infrastructure; as a multi-cloud deployment distributed across two or more cloud providers for redundancy, latency optimization, or regulatory compliance; as an edge computing deployment executing at or near a network edge location; as a high-performance computing (HPC) cluster utilizing job scheduling systems (such as SLURM, PBS, or HTCondor); as a GPU-accelerated computing instance utilizing hardware accelerators (such as NVIDIA A100, H100, or equivalent GPU or TPU hardware) for computationally intensive operations including large language model inference and text-to-speech synthesis; or as any combination of the foregoing architectures. The execution environments 201 and 202 may communicate via any suitable inter-process or inter-node communication mechanism, including shared memory, Unix domain sockets, named pipes, loopback network interfaces, local area network connections, wide area network connections, virtual private network tunnels, software-defined networking overlays, service mesh proxies (such as Envoy, Linkerd, or Istio sidecar proxies), API gateways, load balancers, or the public Internet. Data persistence for the corpus 209 may be implemented using any suitable storage technology, including local file systems, network-attached storage (NAS), storage area networks (SANs), object storage services (such as Amazon S3, Azure Blob Storage, or Google Cloud Storage), relational database management systems (such as PostgreSQL, MySQL, or Microsoft SQL Server), NoSQL databases (such as MongoDB, Apache Cassandra, or Amazon DynamoDB), or distributed file systems (such as HDFS or Ceph). The particular deployment topology, hardware configuration, and communication architecture may be matters of implementation choice and may not affect the logical operation of the system 200 as described herein.

Each of the components illustrated in FIG. 2, including the interface instructions 204, the context 205, the prompt 206, the TTS instructions 207, the evaluator 208, the corpus 209, the audio perturbation instructions 210, and the audio generation instructions 211, may be implemented as software instructions stored on one or more non-transitory computer-readable storage media (such as non-transitory computer-readable medium 607 of FIG. 6) and executed by one or more processors (such as processor 604 of FIG. 6). The computing environment 600 of FIG. 6 may be an example of a computing environment suitable for hosting and executing the components of system 200. In such an implementation, the corpus generation instructions 608 stored on the non-transitory computer-readable medium 607 may implement the functional components of system 200, with the processor 604 executing those instructions to perform the corpus generation operations described herein. The speaker model 203 hosted in the second execution environment 202 may be accessed by the first execution environment 201 via the communications system 605 and the communication network 601, or via any of the inter-process or inter-node communication mechanisms described above.

In various embodiments, one or more of the execution environments 201 and 202 may employ hardware accelerators or specialized processing hardware to improve the computational efficiency and throughput of the corpus generation pipeline. Such hardware accelerators may include, without limitation, graphics processing units (GPUs), tensor processing units (TPUs), field-programmable gate arrays (FPGAs), application-specific integrated circuits (ASICs) optimized for machine learning inference or digital signal processing, digital signal processors (DSPs), and neuromorphic computing circuits (such as Intel Loihi or IBM TrueNorth architectures). Hardware accelerators may be particularly advantageous for accelerating large language model inference performed by the speaker model 203 during candidate utterance generation, for accelerating text-to-speech synthesis performed by the TTS instructions 207 and audio generation instructions 211, and for accelerating the deterministic acoustic signal transformation operations performed by the audio perturbation instructions 210. Where the corpus generation system iterates across a plurality of error types in the predefined error taxonomy and generates large volumes of candidate utterances, hardware acceleration may substantially reduce the time required to produce a complete, quality-controlled corpus. The selection and deployment of hardware accelerators may be a matter of implementation choice and may not alter the logical operation of system 200 as described herein. All references to a “processor” herein may encompass general-purpose processors, multi-core processors, and any of the foregoing hardware accelerators or specialized processing units, whether employed individually or in combination.

The corpus generation system may provide an integrated pipeline architecture that may combine error-type-conditioned prompt generation, LLM-constrained candidate utterance production, text-to-speech conversion, deterministic acoustic signal transformation, automated quality scoring with threshold-based filtering, and structured corpus assembly into a single automated closed-loop system. This pipeline architecture may automate the end-to-end workflow from error-type specification to quality-controlled corpus output. The quality scoring mechanism (whether implemented by an LLM acting as a judge, by human annotators, or by a combination of both) may serve as one component within this integrated pipeline.

The corpus produced by the corpus generation system (system 200, method 400) may be structured, labeled, quality-scored, and formatted for consumption by downstream technical systems. Each entry in the corpus may comprise: (a) a candidate utterance text string annotated with a target error type label drawn from the predefined error taxonomy; (b) an acoustically-transformed audio waveform file produced by the TTS-DSP pipeline, in a standard audio format (e.g., WAV, FLAC, or OGG) suitable for ingestion by downstream ASR or speech processing systems; (c) a computed quality score (a numerical value on a defined scale) assessing the extent to which the candidate utterance exhibits the target error type; and (d) session metadata including the generation prompt template, the LLM model identifier, the acoustic perturbation parameters applied, and the session context. This structured, multi-modal data format (comprising aligned text, audio, labels, scores, and metadata) may be specifically designed for use as training data, evaluation data, or augmentation data in downstream AI/ML pipelines. The corpus may not be a collection of unstructured text or audio; it may be a curated, quality-controlled dataset with defined schema, labeling conventions, and quality thresholds that may enable reproducible downstream use.

The corpus may be consumed by downstream technical systems in several specific ways. First, the corpus may be used as training data for fine-tuning ASR models to adjust their transcription accuracy on disordered speech inputs, as described above. Second, the corpus may be used as training data for fine-tuning conversational AI models (including LLM-based dialogue systems) to adjust their response quality when interacting with speakers who produce disordered or atypical speech, by providing the model with labeled examples of error-typed utterances paired with contextually appropriate responses. Third, the corpus may be used as evaluation benchmarks for assessing the robustness of existing AI systems to disordered speech inputs, by supplying the corpus's acoustically-transformed audio to a target system and measuring the system's output quality against the corpus's error type labels and quality scores. Fourth, the corpus may be used as augmentation data for clinical natural language understanding (NLU) models that must parse and interpret disordered language inputs in healthcare settings (such as clinical documentation systems, patient intake systems, or telehealth platforms). In each of these downstream uses, the corpus may function as a technical input to a technical system.

The prompt 206 may be a generation prompt specifying a target error type from the predefined error taxonomy and constraining token generation of the first LLM such that each candidate utterance conforms solely to the target error type. The generation prompt may optionally include a context 205. In one embodiment, the generation prompt may embed labeled examples of the target error type (one/few-shot prompting). The system may generate, using the AI speaker agent (speaker model 203) operating under the generation prompt, a plurality of candidate utterances. Candidate utterances may be generated in a standalone fashion or through a structured dialogue session between the AI speaker agent and an AI interlocutor agent.

For each candidate utterance, the system may convert the candidate utterance to synthesized speech using the TTS instructions 207 and/or audio generation instructions 211. The system may then apply, using the audio perturbation instructions 210, an acoustic signal transformation to the synthesized speech based on acoustic characteristics associated with the target error type. The transformation may comprise one or more of: insertion of pauses; introduction of a delay at the initiation of speech; elongation of syllable or vowel duration within generated words; and application of one or more acoustic perturbations to the synthesized speech signal. The system may compute, using the evaluator 208, a respective quality score for each candidate utterance assessing the extent to which the candidate utterance exhibits the target error type. Quality score computation may be performed by an LLM acting as a judge, by human annotators, or by a combination of both.

The system may store in corpus 209: (i) candidate utterances for which the respective computed quality score satisfies a minimum quality score value; (ii) acoustically-transformed synthesized speech corresponding to stored candidate utterances; (iii) target error type labels identifying target error types of stored candidate utterances; and (iv) quality scores computed for stored candidate utterances. Transcripts may be stored in structured formats such as JSON and may be subsequently converted to CSV for human review. Generated corpora may be used to train conversational AI systems to be robust when conversing with disordered speech speakers. In certain embodiments, the corpus generation system may be configured to generate labeled corpora in a plurality of target languages, including but not limited to Spanish, French, Mandarin Chinese, Arabic, Portuguese, German, Japanese, Korean, and Hindi, by iterating across language-specific error taxonomy entries and language-parameterized prompt templates, TTS voice models, and STT language models for each target language. Such multilingual corpora may be used to train or fine-tune multilingual ASR systems, multilingual conversational AI agents, or language-specific clinical NLU models to be robust to disordered speech inputs in the respective target languages. The generated corpus may not be limited to clinical or speech-therapy applications. Labeled corpora generated by the system may be used to train or fine-tune AI models for customer service interactions, automated ordering systems, hospitality services, healthcare intake systems, or any other domain in which a conversational AI system will interact with speakers exhibiting non-standard or variable speech-language patterns. The corpus may further be used as evaluation benchmarks, as augmentation datasets for existing training pipelines, or as data for training speech recognition systems to be robust to atypical speech inputs.

In one embodiment, the system may iterate the generation session across each error type in the predefined error taxonomy—regenerating the generation prompt for each error type, generating a further plurality of candidate utterances, and storing each candidate utterance satisfying the minimum quality score with a respective target error type label identifying the respective error type for the respective iteration.

In one embodiment, candidate utterances for the corpus may be generated through the dialogue simulation architecture of FIG. 1 and FIG. 5. The system may provide a shared context stimulus comprising a session goal to both the AI speaker agent and an AI interlocutor agent comprising a second large language model; may generate an interlocutor prompt constraining the second large language model such that, for each candidate utterance received from the AI speaker agent, the AI interlocutor agent identifies the target error type present in the received candidate utterance and generates a response utterance with a response structure determined by the session goal; and may iteratively execute the dialogue session following the turn-based TTS/STT pipeline described above with respect to FIG. 1 and FIG. 5. The transcripts of the dialogue session may be stored in the corpus, annotated with the target error type label corresponding to the target error type.

Referring to FIG. 4, method 400 may be a method for generating a speech corpus according to an embodiment of the present disclosure. In step 401 (Generate Generation Prompt), the system may generate a generation prompt for the AI speaker agent (speaker model 203), wherein the generation prompt may specify a target error type selected from the predefined error taxonomy and may constrain token generation of the first large language model such that each candidate utterance produced by the AI speaker agent conforms solely to the target error type. The generation prompt may optionally incorporate the context 205 and may embed labeled examples of the target error type (one-shot or few-shot prompting). In step 402 (Generate Candidate Utterances), the system may generate, using the AI speaker agent operating under the generation prompt, a plurality of candidate utterances. Candidate utterances may be generated in a standalone fashion or through a structured dialogue session between the AI speaker agent and an AI interlocutor agent, as further described with respect to FIG. 5. In step 403 (Convert Candidate Utterance to Synthesized Speech), for each candidate utterance, the system may convert the candidate utterance to synthesized speech using the TTS instructions 207 and/or the audio generation instructions 211. In step 404 (Apply Acoustic Signal Transformation), the system may apply, using the audio perturbation instructions 210, an acoustic signal transformation to the synthesized speech based on acoustic characteristics associated with the target error type, producing acoustically-transformed synthesized speech. In step 405 (Compute Quality Score), the system may compute, using the evaluator 208, a respective quality score for each candidate utterance assessing the extent to which the candidate utterance exhibits the target error type. In step 406 (Store Corpus), the system may store in corpus 209 those candidate utterances for which the computed quality score satisfies a minimum quality score value, along with the corresponding acoustically-transformed synthesized speech, target error type labels, and computed quality scores.

The corpus generation method 400 may thus define an automated, closed-loop pipeline in which each step (from error-type-conditioned prompt generation (step 401) through candidate utterance production (step 402), speech synthesis (step 403), deterministic acoustic signal transformation (step 404), quality scoring (step 405), and threshold-filtered corpus storage (step 406)) may be programmatically orchestrated without manual intervention. This end-to-end automation may integrate multiple heterogeneous computational components (including LLM-based constrained generation, text-to-speech synthesis, deterministic digital signal processing for acoustic transformation, and automated quality evaluation) into a unified pipeline that may produce a structured, labeled, quality-controlled corpus as its output.

The inter-component message passing within the dialogue simulation system (system 100) and the corpus generation system (system 200) may be implemented through defined data interfaces between each pair of adjacent components in the pipeline. Between the prompt construction routine and the LLM agent (speaker model 105 or locutor model 104), the message may comprise an API request payload containing the assembled prompt string, the current dialogue history buffer (as an ordered list of prior turn text strings), and model inference parameters (such as temperature, top-p, maximum token count, and stop sequences); the LLM agent may return an API response payload containing the generated text utterance. Between the LLM agent and the TTS engine (TTS instruction set 110 or 114), the message may comprise the generated text utterance string and TTS configuration parameters (such as voice identifier, speaking rate, pitch, and output audio format); the TTS engine may return an audio waveform in the specified format. Between the TTS engine and the DSP pipeline (for speaker agent turns), the message may comprise the audio waveform and a DSP configuration object specifying the acoustic perturbation parameters for the current error type (such as time-stretch factor, silence insertion positions and durations, onset delay duration, and spectral modification parameters); the DSP pipeline may return the acoustically-transformed audio waveform. Between the DSP pipeline (or TTS engine, for interlocutor turns) and the STT engine (STT instruction set 111 or 113), the message may comprise the audio waveform and STT configuration parameters (such as language, model size, and decoding strategy); the STT engine may return a text transcript string. Between the STT engine and the receiving agent's prompt construction routine, the message may comprise the text transcript string, which may be appended to the receiving agent's dialogue history buffer. Between the dialogue loop controller and the evaluation instruction set 115, the message may comprise the completed dialogue history buffers for both agents, the session metadata, and the evaluation configuration (specifying which discourse quality metrics to compute and the scoring rubric); the evaluation instruction set 115 may return computed metric values. Between the evaluation instruction set 115 and the corpus storage routine, the message may comprise the session transcript, computed metrics, and session metadata, which may be serialized to the corpus storage format. Each of these inter-component messages may be transmitted via the communication mechanisms described above (including API calls, function invocations, shared memory access, or network requests, depending on the deployment topology) and may be defined by a structured data schema that may ensure type safety and data integrity across the pipeline.

In certain embodiments, the disclosed systems and methods may define a specific, multi-component technical pipeline architecture—comprising error-type-conditioned prompt generation from a formal error taxonomy, dual-agent turn-level instruction chaining through a TTS/STT acoustic communication channel, deterministic DSP-based acoustic signal transformation, and automated quality-gated corpus assembly. In some embodiments, the specific external computational architecture may constrain, transform, evaluate, and curate the LLM's outputs through a defined sequence of heterogeneous computational operations (LLM inference, TTS synthesis, deterministic DSP transformation, STT transcription, automated quality scoring, and threshold-filtered storage). The specification may disclose, for each step, the specific software operation that implements it, the specific technical function that operation may perform, and the specific technical effect that operation may produce within the pipeline.

Referring to FIG. 6, computing environment 600 may be connected via a communication network 601 and may comprise one or more servers 602, 603, 610 and a user computer 611. A server (such as server 603) may include a processor 604 and a communications system 605. The server may include or may be connected to a non-transitory computer-readable medium 607 storing one or more of: conversation simulation instructions 606, corpus generation instructions 608, and agent evaluation instructions 609. The processor 604 may execute the instructions stored on the non-transitory computer-readable medium 607. The computing environment 600 may be illustrative and non-limiting; the various computing environments may be implemented as separate physical servers, virtual machines, cloud computing instances, or any other suitable architecture.

The mobile device may include subcomponents such as a processor, which may be a general-purpose processor, application-specific integrated circuit (ASIC), graphics processing unit (GPU), or other dedicated hardware optimized for speech processing and machine learning tasks. A memory, which may be volatile (RAM) or non-volatile (ROM, flash storage, SSD), may store user profiles, therapy settings, and application data. Additionally, the mobile device may include a display screen, a microphone for capturing user speech, a user input (e.g., touchscreen, keyboard, or voice commands), and a communications interface, which may support Wi-Fi, Bluetooth, cellular (3G, 4G, 5G), or other network connectivity options to transmit data to a server or other remote systems.

The server may include multiple processing cores, storage for storing therapy prescriptions, patient progress logs, and historical speech data, and one or more network interfaces for secure data transmission. In some embodiments, the server may integrate with an electronic medical records (EMR) system to provide seamless access to patient data for healthcare providers. The server may also host a web-based provider portal, which may allow clinicians to remotely monitor patient progress, configure therapy settings, and review AI-generated reports on speech accuracy trends, fluency improvements, and engagement levels. The server may further include or connect to executable services such as language models and transformer models (e.g., text-to-speech, speech-to-text, etc.). In some cases, the server may store patient data associated with the models (e.g., patient-specific model parameters), or patient-specific model instances. For example, the server may store samples of, or representations of, the patient's voice for a voice imitation text-to-speech model. The server may also integrate with or transmit data to a cloud-based or hosted large language model (LLM).

A workstation may be provided for healthcare providers or speech-language pathologists to configure therapy prescriptions and review patient progress. The workstation may be a standalone computer, a cloud-based interface, or an integrated component of an EMR system. The workstation may include a graphical user interface (GUI) that may display patient session logs, adherence reports, and automated insights generated by the server. In some implementations, the workstation may allow providers to fine-tune therapy plans, adjust prompt complexity, and manually override automated prescription settings.

A communication network may connect the mobile device, server, and workstation. The communication network may include the Internet, cellular networks, local area networks (LANs), or other communication pathways. The network may facilitate real-time data exchange, remote therapy session scheduling, and software updates for the mobile application. The system may support end-to-end encryption protocols to ensure data security and privacy compliance.

In some embodiments, the system may further include cloud-based storage and processing resources, which may enable scalable data management and computationally intensive operations such as natural language processing, phoneme similarity analysis, and automated speech error detection. Cloud services may allow seamless syncing of therapy progress across multiple devices, ensuring that therapy sessions remain uninterrupted even if a patient switches devices.

Both CoT and zero-shot approaches may perform well across all measures. For global coherence, all conditions may demonstrate consistently high scores. The zero-shot+picture condition achieved a mean of 5.0 (SD=0.0), indicating no variability. The CoT+topic condition followed closely, with strong coherence and minimal variation, and zero-shot+topic and CoT+picture conditions also performed well, suggesting that both CoT and zero-shot approaches may maintain high global coherence regardless of whether paired with pictures or topics. For grammaticality, results may be highly consistent. CoT+topic, zero-shot+picture, and zero-shot+topic all achieved a mean score of 5.0 (SD=0.0), indicating flawless grammatical accuracy. These findings may suggest that the AI interlocutor agent's grammaticality and global coherence metrics may be very high regardless of prompting technique, semantic parameter, and aphasic error type. The key finding may suggest that the AI interlocutor agent's performance may be optimized for adhering to the therapeutic protocol through a well-crafted zero-shot prompt. Conversational AI partners, with LLMs as their base technology, may be provided with well-crafted zero-shot prompts that may be sufficient to maximize the pretrained capabilities of state-of-the-art LLMs to implement evidence-based therapy protocols that may be robust against adversarial disordered speech inputs. The AI interlocutor agent demonstrated a degree of stability and consistency in its grammaticality and global coherence across all tested conditions. This finding may indicate that the AI interlocutor agent may not be overly sensitive to how prompts or contexts are framed. This robustness may indicate the potential for flexibility in tailoring sessions without performance degradation when shifting between pictures or topics, given an appropriate structured prompt.

For every LLM type and reasoning variant tested, both human SLP raters rated 100% of utterances as adherent to the RET protocol, and human raters demonstrated high overall accuracy in assigning simulated utterances to the intended aphasic error types, with mean accuracy rates ranging from 81.9% to 99.3% across LLM types and reasoning variants. For response accessibility, different LLM families may demonstrate distinct performance profiles across conditions. Few-shot prompting and advanced reasoning may generally be associated with increased readability and accessibility compared to zero-shot prompting and standard reasoning.

FIG. 7A (Table A1) may illustrate a dialogue with error type “Word Error (Perseveration Error)” and topic “Favorite Fruit.” The AI speaker agent may consistently repeat the word “apple” across turns, simulating perseverative speech. The AI interlocutor agent may respond by acknowledging the patient's production and progressively elaborating on the conversation topic, consistent with a response elaboration training protocol.

FIG. 7B (Table A2) may illustrate a dialogue with error type “Word Error (Syntactic Error)” and topic “Favorite Leisure Activity.” The AI speaker agent may produce utterances with disrupted word order (e.g., “Midfield run, I yes, run ball chase, I”), simulating syntactic disruptions characteristic of certain aphasia presentations.

FIG. 7C (Table A3) may illustrate a dialogue with error type “Discourse Error (Language Mixing)” and topic “First Car.” The AI speaker agent may produce utterances mixing English with Spanish vocabulary (e.g., “For Modelo El Coche,” “Road trip with Amigos”), simulating language-mixing behavior.

The following example dialogues may further illustrate the operation of the dialogue simulation system.

Example 1: Tangential Speech. The AI speaker agent may be programmed to demonstrate tangential speech. Tangential speech may be common in conditions (such as dementia) where patients drift off topic. The purpose of this configuration may be to simulate that pattern so that AI clinicians may adapt accordingly. An illustrative interaction may be as follows: AI Clinician: “Hello, I hope you're doing well. Let's talk about favorite leisure activity.” AI Speaker: “Watching TV.” AI Clinician: “That's great. Watching TV can be quite entertaining.” AI Speaker: “I like puppies. They're cute.” [tangential speech] AI Clinician: “You've mentioned puppies, but let's try to stay focused.”

Example 2: Word Error (Perseveration), Topic: Favorite Fruit. The following example dialogue may illustrate the operation of the dialogue simulation system with a perseveration error type: AI Clinician (Re-Agent): “Hi there! Let's get started. Can you tell me about your favorite fruit?” AI Speaker (AI-Aphasic): “Apple apple.” AI Clinician: “Great! I see you like apples. Can you tell me why apples are your favorite fruit?” AI Speaker: “apple. Sweet apple.” AI Clinician: “Apples are sweet, that's a good reason to like them! Can you tell me more about when you like to eat apples?” AI Speaker: “Apple. Red Breakfast?” The dialogue may continue, with the AI speaker agent producing perseverative use of “apple” throughout, and the AI clinician acknowledging and elaborating in accordance with the RET protocol.

Example 3: Word Error (Syntactic), Topic: Favorite Leisure Activity. AI Clinician: “Hi! Let's start with our first topic. Can you tell me what your favorite leisure activity is?” AI Speaker: “Hello. Play soccer.” AI Clinician: “Playing soccer sounds fun! Can you tell me more about what position you like to play?” AI Speaker: “Midfield run, I yes, run ball chase, I.” [syntactic error] AI Clinician: “You like playing in midfield, where you get to run and chase the ball. That's exciting!”

Example 4: Discourse Error (Language Mixing), Topic: First Car. AI Clinician: “Hello! Can you tell me about your first car?” AI Speaker: “For Modelo El Coche.” [language mixing—Spanish: “The Car Model”] AI Clinician: “It seems you mentioned ‘model’ and ‘car’ in Spanish. Please respond in English alone. Can you tell me more about the model of your first car?” AI Speaker: “L Ford.” AI Clinician: “Your first car was a Ford. Thank you for sharing! Can you tell me about any memorable experiences you had with your red Ford?” AI Speaker: “Road trip with Amigos. So fun.” [further language mixing]

Although the foregoing description may emphasize the speech therapy application, the technology disclosed herein may be broadly applicable to any domain requiring structured simulation of a speaker producing constrained linguistic outputs in dialogue with a responsive conversational agent. Non-limiting examples of such domains may include: (i) evaluation of customer relationship management (CRM) agents and customer service conversational AI systems, including agents that interact with customers who have communication difficulties, non-native language backgrounds, or variable speech patterns; (ii) evaluation of help desk and technical support agents interacting with users who produce atypical or error-prone speech; (iii) evaluation of automated ordering system agents (such as restaurant, retail, or food-delivery ordering agents) interacting with speakers with diverse accents, language backgrounds, or speech patterns; (iv) evaluation of hospitality agents (such as hotel reservation or concierge agents) interacting with international guests; (v) evaluation of hospital and healthcare communication agents (such as intake agents, appointment scheduling agents, or patient communication agents) interacting with patients who have communication disorders; (vi) evaluation of speech therapist agents prior to clinical deployment; (vii) simulation of dementia-related speech-language patterns; (viii) simulation of language learner productions for second-language acquisition research; (ix) generation of training data for speech recognition systems intended to handle atypical speech; (x) pre-deployment testing of AI-powered communication support tools for accessibility applications; and (xi) research into human-machine communication in noisy, multilingual, or otherwise challenging acoustic and linguistic environments. The predefined error taxonomy may be extended by adding new error types. The system may encompass broader applicability beyond clinical settings (disordered speech may occur outside therapy, and accents and mixed-language speech may also be modeled).

The disclosed technology may be used to generate synthetic speech datasets, which may be used to train conversational AI systems to be robust when conversing with disordered speech speakers. ABCD may represent a computational approach to accelerate the preclinical testing of conversational AI partners for speech-language therapy. By simulating patient-clinician natural spoken dialogue, ABCD may address the logistical, financial, and resource challenges of collecting human disordered speech data for fine-tuning pretrained AI models during preclinical testing. While ABCD may be demonstrated herein in the context of aphasia therapy, the method may provide a scalable and generalizable approach for piloting conversational AI agents across diverse clinical and nonclinical applications. For example, a developer of a commercial CRM agent, help desk agent, ordering system agent, hotel concierge agent, or hospital intake agent may use the ABCD framework to source their candidate agent, configure a speaker agent to represent the target user population (including users with communication differences, non-native speakers, or users with variable speech patterns), run simulated multi-turn dialogues, and use the resulting evaluation metrics to select the best-performing agent configuration or to identify and remediate performance gaps before live deployment. The system may interface with candidate agents via standard commercial APIs (such as REST APIs provided by CRM platforms, help desk platforms, or hospitality management systems) which may enable integration of externally-hosted candidate agents into the simulation pipeline without requiring access to the agent's internal model or training data. As AI systems (including LLMs and advanced speech technologies) continue to evolve rapidly, ABCD's capabilities may scale accordingly, further enhancing its potential for clinical integration. Future studies should introduce noise sources into the models to simulate natural spoken dialogues involving disordered speech in noise caused by environmental sources or physiological ones (e.g., speech distortions due to motor speech disorders). In addition, future studies should explore the accuracy of simulated conversational agents using diverse LLMs and prompting techniques. Although evaluated in therapeutic settings, disordered speech may occur outside therapy, and the therapeutic domain may demonstrate the broader applicability of the disclosed technology. The ABCD system may encompass all such aspects. The approach may generalize to other inclusive communication settings where comprehension demands are high, and may offer a template for systematic, multidimensional evaluation of spoken conversational AI agents prior to deployment in real-world environments.

The techniques, technologies, algorithms, and aspects described herein may be implemented in a variety of practical applications, which may serve to be used in systems and methods used or performed by several different individuals, companies, and/or institutions involved in training, simulation, education, workforce development, dialogue system design, and the like.

Aspects of the technology may further include:

A system comprising: a processor; and a non-transitory computer-readable storage medium storing instructions that, when executed by the processor, cause the system to: generate a generation prompt for an AI speaker agent, the AI speaker agent comprising a first large language model, the generation prompt specifying a target error type selected from a predefined error taxonomy and constraining token generation of the first large language model such that each candidate utterance produced by the AI speaker agent during a generation session conforms solely to the target error type; generate, using the AI speaker agent operating under the generation prompt, a plurality of candidate utterances; for each candidate utterance of the plurality of candidate utterances: convert the respective candidate utterance to respective synthesized speech; apply a respective acoustic signal transformation to the respective synthesized speech of the respective candidate utterance based on acoustic characteristics associated with the target error type; and compute a respective quality score for the respective candidate utterance to assess an extent to which the respective candidate utterance exhibits the target error type; and store a corpus comprising: candidate utterances for which the respective computed quality score satisfies a minimum quality score value; acoustically-transformed synthesized speech corresponding to stored candidate utterances; target error type labels identifying target error types of stored candidate utterances; and quality scores computed for stored candidate utterances.

The system of any previous aspect, further comprising an agent interface configured to receive a definition of the AI speaker agent comprising one or more of: a model identifier specifying a pre-trained first large language model, or a set of model parameters for a fine-tuned large language model.

The system of any previous aspect, wherein the generation prompt embeds, for the target error type, a labeled example comprising an example utterance exhibiting the target error type.

The system of any previous aspect, wherein the instructions further cause the system to iterate the generation session across each error type in the predefined error taxonomy by, for each respective error type: regenerating the generation prompt to specify the respective error type and to embed labeled examples for the respective error type; generating, using the AI speaker agent operating under the respective regenerated generation prompt, a respective further plurality of candidate utterances; and storing each respective further candidate utterance satisfying the minimum quality score value in the corpus with a respective target error type label identifying the respective error type for the respective iteration.

The system of any previous aspect, wherein the instructions further cause the system to: provide a shared context stimulus comprising a session goal for a dialogue session to the AI speaker agent and to an AI interlocutor agent comprising a second large language model; generate an interlocutor prompt for the AI interlocutor agent constraining the second large language model such that, for each candidate utterance received from the AI speaker agent, the AI interlocutor agent identifies the target error type present in the received candidate utterance and generates a response utterance with a response structure determined by the session goal; iteratively execute the dialogue session between the AI speaker agent and the AI interlocutor agent to generate the plurality of candidate utterances, wherein each iteration corresponds to a respective dialogue turn and comprises: converting a first text utterance generated by the AI interlocutor agent to first synthesized speech; converting the first synthesized speech to a first text transcript; supplying the first text transcript to the AI speaker agent as the input for a current speaker turn; converting a candidate utterance generated by the AI speaker agent in response to the first text transcript to second synthesized speech; applying the acoustic signal transformation to the second synthesized speech based on acoustic characteristics associated with the target error type; and converting the acoustically-transformed second synthesized speech to a second text transcript, the second text transcript being supplied to the AI interlocutor agent as input for a subsequent interlocutor turn; and store, in the corpus, transcripts of the dialogue session annotated with the target error type label corresponding to the target error type.

The system of any previous aspect, wherein the acoustic signal transformation comprises one or more of insertion of pauses into the synthesized speech output, introduction of a delay at the initiation of speech, elongation of syllable or vowel duration within generated words, or application of one or more acoustic perturbations to the synthesized speech signal.

The system of any previous aspect, wherein: the generation prompt embeds, for the target error type, a labeled example comprising an example utterance exhibiting the target error type; the instructions further cause the system to iterate the generation session across each error type in the predefined error taxonomy by, for each respective error type: regenerating the generation prompt to specify the respective error type and to embed labeled examples for the respective error type; generating, using the AI speaker agent operating under the respective regenerated generation prompt, a respective further plurality of candidate utterances; and storing each respective further candidate utterance satisfying the minimum quality score value in the corpus with a respective target error type label identifying the respective error type for the respective iteration; and the acoustic signal transformation comprises one or more of insertion of pauses into the synthesized speech, introduction of a delay at the initiation of speech, elongation of syllable or vowel duration within generated words, or application of one or more acoustic perturbations to the synthesized speech signal.

A method comprising: generating, by a processor, a generation prompt for an AI speaker agent, the AI speaker agent comprising a first large language model, the generation prompt specifying a target error type selected from a predefined error taxonomy and constraining token generation of the first large language model such that each candidate utterance produced by the AI speaker agent during a generation session conforms solely to the target error type; generating, using the AI speaker agent operating under the generation prompt, a plurality of candidate utterances; for each candidate utterance of the plurality of candidate utterances: converting the respective candidate utterance to respective synthesized speech; applying a respective acoustic signal transformation to the respective synthesized speech of the respective candidate utterance based on acoustic characteristics associated with the target error type; and computing a respective quality score for the respective candidate utterance to assess an extent to which the respective candidate utterance exhibits the target error type; and storing a corpus comprising: candidate utterances for which the respective computed quality score satisfies a minimum quality score value; acoustically-transformed synthesized speech corresponding to stored candidate utterances; target error type labels identifying target error types of stored candidate utterances; and quality scores computed for stored candidate utterances.

The method of any previous method, further comprising receiving, via an agent interface, a definition of the AI speaker agent comprising one or more of: a model identifier specifying a pre-trained first large language model, or a set of model parameters for a fine-tuned large language model.

The method of any previous method, wherein the generation prompt embeds, for the target error type, a labeled example comprising an example utterance exhibiting the target error type.

The method of any previous method, further comprising iterating the generation session across each error type in the predefined error taxonomy by, for each respective error type: regenerating the generation prompt to specify the respective error type and to embed labeled examples for the respective error type; generating, using the AI speaker agent operating under the respective regenerated generation prompt, a respective further plurality of candidate utterances; and storing each respective further candidate utterance satisfying the minimum quality score value in the corpus with a respective target error type label identifying the respective error type for the respective iteration.

The method of any previous method, further comprising: providing a shared context stimulus comprising a session goal for a dialogue session to the AI speaker agent and to an AI interlocutor agent comprising a second large language model; generating an interlocutor prompt for the AI interlocutor agent constraining the second large language model such that, for each candidate utterance received from the AI speaker agent, the AI interlocutor agent identifies the target error type present in the received candidate utterance and generates a response utterance with a response structure determined by the session goal; iteratively executing the dialogue session between the AI speaker agent and the AI interlocutor agent to generate the plurality of candidate utterances, wherein each iteration corresponds to a respective dialogue turn and comprises: converting a first text utterance generated by the AI interlocutor agent to first synthesized speech; converting the first synthesized speech to a first text transcript; supplying the first text transcript to the AI speaker agent as the input for a current speaker turn; converting a candidate utterance generated by the AI speaker agent in response to the first text transcript to second synthesized speech; applying the acoustic signal transformation to the second synthesized speech based on acoustic characteristics associated with the target error type; and converting the acoustically-transformed second synthesized speech to a second text transcript, the second text transcript being supplied to the AI interlocutor agent as input for a subsequent interlocutor turn; and storing, in the corpus, transcripts of the dialogue session annotated with the target error type label corresponding to the target error type.

The method of any previous method, wherein the acoustic signal transformation comprises one or more of insertion of pauses into the synthesized speech output, introduction of a delay at the initiation of speech, elongation of syllable or vowel duration within generated words, or application of one or more acoustic perturbations to the synthesized speech signal.

The method of any previous method, wherein: the generation prompt embeds, for the target error type, a labeled example comprising an example utterance exhibiting the target error type; the method further comprises iterating the generation session across each error type in the predefined error taxonomy by, for each respective error type: regenerating the generation prompt to specify the respective error type and to embed labeled examples for the respective error type; generating, using the AI speaker agent operating under the respective regenerated generation prompt, a respective further plurality of candidate utterances; and storing each respective further candidate utterance satisfying the minimum quality score value in the corpus with a respective target error type label identifying the respective error type for the respective iteration; and the acoustic signal transformation comprises one or more of insertion of pauses into the synthesized speech, introduction of a delay at the initiation of speech, elongation of syllable or vowel duration within generated words, or application of one or more acoustic perturbations to the synthesized speech signal.

A non-transitory computer-readable storage medium storing instructions that, when executed by a processor, cause a system to perform operations comprising: generating a generation prompt for an AI speaker agent, the AI speaker agent comprising a first large language model, the generation prompt specifying a target error type selected from a predefined error taxonomy and constraining token generation of the first large language model such that each candidate utterance produced by the AI speaker agent during a generation session conforms solely to the target error type; generating, using the AI speaker agent operating under the generation prompt, a plurality of candidate utterances; for each candidate utterance of the plurality of candidate utterances: converting the respective candidate utterance to respective synthesized speech; applying a respective acoustic signal transformation to the respective synthesized speech of the respective candidate utterance based on acoustic characteristics associated with the target error type; and computing a respective quality score for the respective candidate utterance to assess an extent to which the respective candidate utterance exhibits the target error type; and storing a corpus comprising: candidate utterances for which the respective computed quality score satisfies a minimum quality score value; acoustically-transformed synthesized speech corresponding to stored candidate utterances; target error type labels identifying target error types of stored candidate utterances; and quality scores computed for stored candidate utterances.

The non-transitory computer-readable storage medium of any previous medium, wherein the operations further comprise receiving, via an agent interface, a definition of the AI speaker agent comprising one or more of: a model identifier specifying a pre-trained first large language model, or a set of model parameters for a fine-tuned large language model.

The non-transitory computer-readable storage medium of any previous medium, wherein the generation prompt embeds, for the target error type, a labeled example comprising an example utterance exhibiting the target error type.

The non-transitory computer-readable storage medium of any previous medium, wherein the operations further comprise iterating the generation session across each error type in the predefined error taxonomy by, for each respective error type: regenerating the generation prompt to specify the respective error type and to embed labeled examples for the respective error type; generating, using the AI speaker agent operating under the respective regenerated generation prompt, a respective further plurality of candidate utterances; and storing each respective further candidate utterance satisfying the minimum quality score value in the corpus with a respective target error type label identifying the respective error type for the respective iteration.

The non-transitory computer-readable storage medium of any previous medium, wherein the operations further comprise: providing a shared context stimulus comprising a session goal for a dialogue session to the AI speaker agent and to an AI interlocutor agent comprising a second large language model; generating an interlocutor prompt for the AI interlocutor agent constraining the second large language model such that, for each candidate utterance received from the AI speaker agent, the AI interlocutor agent identifies the target error type present in the received candidate utterance and generates a response utterance with a response structure determined by the session goal; iteratively executing the dialogue session between the AI speaker agent and the AI interlocutor agent to generate the plurality of candidate utterances, wherein each iteration corresponds to a respective dialogue turn and comprises: converting a first text utterance generated by the AI interlocutor agent to first synthesized speech; converting the first synthesized speech to a first text transcript; supplying the first text transcript to the AI speaker agent as the input for a current speaker turn; converting a candidate utterance generated by the AI speaker agent in response to the first text transcript to second synthesized speech; applying the acoustic signal transformation to the second synthesized speech based on acoustic characteristics associated with the target error type; and converting the acoustically-transformed second synthesized speech to a second text transcript, the second text transcript being supplied to the AI interlocutor agent as input for a subsequent interlocutor turn; and storing, in the corpus, transcripts of the dialogue session annotated with the target error type label corresponding to the target error type.

The non-transitory computer-readable storage medium of any previous medium, wherein the acoustic signal transformation comprises one or more of insertion of pauses into the synthesized speech output, introduction of a delay at the initiation of speech, elongation of syllable or vowel duration within generated words, or application of one or more acoustic perturbations to the synthesized speech signal.

In one category of embodiments, systems and methods may be configured to function as a tool to assist enterprise or institutional administrators in deploying tailored dialogue simulation experiences to their users in a prompt and efficient manner. Thus, such embodiments may involve administrator portals that may allow managers or instructors to adjust settings, monitor trainee progress and adherence, and ensure that adaptive dialogue training is available to their users outside of formal training sessions, via mobile, adaptive, and effective delivery approaches. These embodiments may include enriched features for allowing administrators and trainees to communicate and coordinate the delivery of dialogue simulation training on an ongoing basis, such as private messaging, posting results and feedback, and coordinating adjustments to settings and analysis of trends and outliers.

Alternatively, or additionally, the systems and methods described above may be embodied in a more user-driven implementation that may rely on automated logic and/or an AI agent to suggest simulation settings and updates based on user capability and progress. Thus, in such embodiments, an administrator portal may not necessarily be utilized, and instead settings, feedback, and overall management and guidance of training may be performed according to prewritten logic or machine learning-driven rules. For example, as a user develops a given level of proficiency in a dialogue domain, the system may automatically increase the complexity or adversarial difficulty of the simulated dialogue partner's responses. Or, as the system detects a user struggling with given response types or conversation patterns, an LLM may be utilized to give variations of those challenging interaction scenarios that correlate with the user's training objectives.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A system, comprising:
a processor; and
a non-transitory computer-readable storage medium storing instructions that, when executed by the processor, cause the system to:
provide, a shared context stimulus comprising a session goal for a dialogue session to an AI speaker agent comprising a first large language model and an AI interlocutor agent comprising a second large language model;
generate a speaker prompt for the AI speaker agent specifying a target error type and constraining the first large language model to conform utterances produced by the AI speaker agent during the dialogue session to the target error type;
generate an interlocutor prompt for the AI interlocutor agent, the interlocutor prompt constraining the second large language model such that, for each utterance received from the AI speaker agent, the AI interlocutor agent identifies the target error type present in the received utterance and generates a response utterance with a response structure determined by the session goal and received utterance content;
iteratively execute the dialogue session, wherein each iteration of the dialogue session corresponds to a respective dialogue turn and comprises:
converting a first text utterance generated by the AI interlocutor agent to first synthesized speech;
converting the first synthesized speech to a first text transcript;
supplying the first text transcript to the AI speaker agent as the input for a current speaker turn;
converting a second text utterance generated by the AI speaker agent in response to the first text transcript to second synthesized speech;
applying an acoustic signal transformation to the second synthesized speech based on acoustic characteristics associated with the target error type to produce acoustically-transformed second synthesized speech; and
converting the acoustically-transformed second synthesized speech to a second text transcript, the second text transcript being supplied to the AI interlocutor agent as input for a subsequent interlocutor turn; and
store, in the non-transitory computer-readable storage medium, a transcript of the dialogue session.

2. The system of claim 1, wherein the instructions further cause the system to:
compute a discourse quality metric for utterances generated by the AI interlocutor agent across the dialogue session, the discourse quality metric comprising one or more of syntactic well-formedness, semantic consistency between utterances, or topical consistency with the session goal.

3. The system of claim 2, wherein the instructions further cause the system to:
regenerate the speaker prompt for each of a plurality of target error types in a predefined error taxonomy;
execute a respective dialogue session for each of the plurality of target error types; and
generate a performance report identifying a respective discourse quality metric for each target error type of the plurality of target error types.

4. The system of claim 1, wherein at least one of the speaker prompt or the interlocutor prompt comprises a sample utterance exhibiting the target error type paired with a corresponding interlocutor response.

5. The system of claim 1, wherein the shared context stimulus comprises a visual image provided as input to both the AI speaker agent and the AI interlocutor agent and the session goal comprises a communicative task defined with respect to the content of the visual image.

6. The system of claim 1, further comprising an agent interface configured to receive one or more of:
a model identifier specifying the first large language model or the second large language model;
a prompt template to be applied to the first or second large language model as the speaker prompt or the interlocutor prompt; or
a set of model parameters to fine-tune the first or second large language model.

7. The system of claim 1, wherein the AI speaker agent is a speech therapy patient agent and the AI interlocutor agent is a speech therapy clinician agent.

8. The system of claim 1, wherein the dialogue session comprises a simulated response elaboration training session.

9. The system of claim 1, wherein the acoustic signal transformation comprises one or more of insertion of pauses into the second synthesized speech, introduction of a delay at the initiation of speech, elongation of syllable or vowel duration within generated words, or application of one or more acoustic perturbations to the second synthesized speech.

10. The system of claim 1, wherein:
the AI speaker agent is a speech therapy patient agent and the AI interlocutor agent is a speech therapy clinician agent;
the dialogue session comprises a simulated response elaboration training session;
the shared context stimulus comprises a visual image provided as input to both the AI speaker agent and the AI interlocutor agent and the session goal comprises a communicative task defined with respect to the content of the visual image;
at least one of the speaker prompt or the interlocutor prompt comprises a sample utterance exhibiting the target error type paired with a corresponding interlocutor response;
the acoustic signal transformation comprises one or more of insertion of pauses into the second synthesized speech, introduction of a delay at the initiation of speech, elongation of syllable or vowel duration within generated words, or application of one or more acoustic perturbations to the second synthesized speech;
the instructions further cause the system to compute a discourse quality metric for utterances generated by the AI interlocutor agent across the dialogue session, the discourse quality metric comprising one or more of syntactic well-formedness, semantic consistency between utterances, or topical consistency with the session goal;
the instructions further cause the system to regenerate the speaker prompt for each of a plurality of target error types in a predefined error taxonomy, execute a respective dialogue session for each of the plurality of target error types, and generate a performance report identifying a respective discourse quality metric for each target error type of the plurality of target error types; and
the system further comprises an agent interface configured to receive one or more of a model identifier specifying the first large language model or the second large language model, a prompt template to be applied to the first or second large language model as the speaker prompt or the interlocutor prompt, or a set of model parameters to fine-tune the first or second large language model.

11. A method, comprising:
providing a shared context stimulus comprising a session goal for a dialogue session to an AI speaker agent comprising a first large language model and an AI interlocutor agent comprising a second large language model;
generating a speaker prompt for the AI speaker agent specifying a target error type and constraining the first large language model to conform utterances produced by the AI speaker agent during the dialogue session to the target error type;
generating an interlocutor prompt for the AI interlocutor agent, the interlocutor prompt constraining the second large language model such that, for each utterance received from the AI speaker agent, the AI interlocutor agent identifies the target error type present in the received utterance and generates a response utterance with a response structure determined by the session goal and received utterance content;
iteratively executing the dialogue session, wherein each iteration of the dialogue session corresponds to a respective dialogue turn and comprises:
converting a first text utterance generated by the AI interlocutor agent to first synthesized speech;
converting the first synthesized speech to a first text transcript;
supplying the first text transcript to the AI speaker agent as the input for a current speaker turn;
converting a second text utterance generated by the AI speaker agent in response to the first text transcript to second synthesized speech;
applying an acoustic signal transformation to the second synthesized speech based on acoustic characteristics associated with the target error type to produce acoustically-transformed second synthesized speech; and
converting the acoustically-transformed second synthesized speech to a second text transcript, the second text transcript being supplied to the AI interlocutor agent as input for a subsequent interlocutor turn; and
storing, in a non-transitory computer-readable storage medium, a transcript of the dialogue session.

12. The method of claim 11, further comprising:
computing a discourse quality metric for utterances generated by the AI interlocutor agent across the dialogue session, the discourse quality metric comprising one or more of syntactic well-formedness, semantic consistency between utterances, or topical consistency with the session goal;
regenerating the speaker prompt for each of a plurality of target error types in a predefined error taxonomy;
executing a respective dialogue session for each of the plurality of target error types; and
generating a performance report identifying a respective discourse quality metric for each target error type of the plurality of target error types.

13. The method of claim 11, wherein at least one of the speaker prompt or the interlocutor prompt comprises a sample utterance exhibiting the target error type paired with a corresponding interlocutor response.

14. The method of claim 11, wherein the shared context stimulus comprises a visual image provided as input to both the AI speaker agent and the AI interlocutor agent and the session goal comprises a communicative task defined with respect to the content of the visual image.

15. The method of claim 11, wherein the acoustic signal transformation comprises one or more of insertion of pauses into the second synthesized speech, introduction of a delay at the initiation of speech, elongation of syllable or vowel duration within generated words, or application of one or more acoustic perturbations to the second synthesized speech.

16. A non-transitory computer-readable storage medium storing instructions that, when executed by a processor, cause a system to:
provide a shared context stimulus comprising a session goal for a dialogue session to an AI speaker agent comprising a first large language model and an AI interlocutor agent comprising a second large language model;
generate a speaker prompt for the AI speaker agent specifying a target error type and constraining the first large language model to conform utterances produced by the AI speaker agent during the dialogue session to the target error type;
generate an interlocutor prompt for the AI interlocutor agent, the interlocutor prompt constraining the second large language model such that, for each utterance received from the AI speaker agent, the AI interlocutor agent identifies the target error type present in the received utterance and generates a response utterance with a response structure determined by the session goal and received utterance content;
iteratively execute the dialogue session, wherein each iteration of the dialogue session corresponds to a respective dialogue turn and comprises:
converting a first text utterance generated by the AI interlocutor agent to first synthesized speech;
converting the first synthesized speech to a first text transcript;
supplying the first text transcript to the AI speaker agent as the input for a current speaker turn;
converting a second text utterance generated by the AI speaker agent in response to the first text transcript to second synthesized speech;
applying an acoustic signal transformation to the second synthesized speech based on acoustic characteristics associated with the target error type to produce acoustically-transformed second synthesized speech; and
converting the acoustically-transformed second synthesized speech to a second text transcript, the second text transcript being supplied to the AI interlocutor agent as input for a subsequent interlocutor turn; and
store a transcript of the dialogue session.

17. The non-transitory computer-readable storage medium of claim 16, wherein the instructions further cause the system to:
compute a discourse quality metric for utterances generated by the AI interlocutor agent across the dialogue session, the discourse quality metric comprising one or more of syntactic well-formedness, semantic consistency between utterances, or topical consistency with the session goal;
regenerate the speaker prompt for each of a plurality of target error types in a predefined error taxonomy;
execute a respective dialogue session for each of the plurality of target error types; and
generate a performance report identifying a respective discourse quality metric for each target error type of the plurality of target error types.

18. The non-transitory computer-readable storage medium of claim 16, wherein the AI speaker agent is a speech therapy patient agent and the AI interlocutor agent is a speech therapy clinician agent.

19. The non-transitory computer-readable storage medium of claim 16, wherein the dialogue session comprises a simulated response elaboration training session.

20. The non-transitory computer-readable storage medium of claim 16, wherein the acoustic signal transformation comprises one or more of insertion of pauses into the second synthesized speech, introduction of a delay at the initiation of speech, elongation of syllable or vowel duration within generated words, or application of one or more acoustic perturbations to the second synthesized speech.
